(19) United States
(12) Patent Application Publication
(10) Pub. No.: US 2015/0056985 A1
(43) Pub. Date: Feb. 26, 2015

(54) APPARATUS AND METHOD FOR IMPLEMENTING A MANUAL PLMN SCAN

(71) Applicant: QUALCOMM Incorporated, San Diego, CA (US)

(72) Inventors: Arvind Swaminathan, San Jose, CA (US); Rajesh Patil, Hyderabad (IN); Shivank Nayak, San Diego, CA (US); Chih-Ping Hsu, San Diego, CA (US); Reza Shahidi, San Diego, CA (US); Mingyan Wang, Shanghai (CN)

(73) Assignee: QUALCOMM Incorporated, San Diego, CA (US)

(21) Appl. No.: 14/229,247

(22) Filed: Mar. 28, 2014

Related U.S. Application Data
(60) Provisional application No. 61/867,708, filed on Aug. 20, 2013.

(51) Int. Cl. H04W 48/16; H04W 88/06; H04W 8/02

(52) U.S. Cl. CPC H04W 48/16; H04W 8/02; H04W 88/06
USPC 455/432.1; 455/434; 455/552.1

(57) ABSTRACT

In various aspects, the disclosure provides the capability for a UE to implement a partial PLMN scan, providing quick results to a user's request for a manual PLMN scan, in a way that is expedited relative to the conventional method of providing PLMN results only when a full scan is completed. In further aspects, the disclosure provides for various optimizations to expedite a PLMN scan, which may be implemented either with the partial PLMN scan, or in a full PLMN scan, to further expedite the provision of PLMN scan results to the user.

### CROSS-REFERENCE TO RELATED APPLICATIONS

This application claims priority to and the benefit of provisional patent application No. 61/867,708, titled, “Apparatus and Method for Implementing a Manual PLMN Scan,” filed in the United States. Patent and Trademark Office on Aug. 20, 2013, the entire content of which is incorporated herein by reference as if fully set forth below and for all applicable purposes.

### TECHNICAL FIELD

Aspects of the present disclosure relate generally to wireless communication systems, and more particularly, to the implementation of a manual scan for a public land mobile network (PLMN) in a wireless communication system.

### BACKGROUND

Wireless communication networks are widely deployed to provide various communication services such as telephony, video, data, messaging, broadcasts, and so on. In many wireless communication networks, a mobile device or user equipment (UE) is enabled to establish voice communication with another user by way of a public land mobile network (PLMN). Each PLMN is identified by a PLMN ID, which generally includes a mobile country code (MCC) and a mobile network code (MNC). The MCC generally identifies the country in which the PLMN is located, and the MNC generally identifies the service provider or operator for that PLMN.

In many cases, there is more than one PLMN that a user can utilize for service at a particular time and location. In such a case, the UE may perform a PLMN scan, wherein the UE scans for available PLMNs and accordingly selects which PLMN to utilize for service.

As the demand for mobile broadband access continues to increase, research and development continue to advance wireless communication technologies not only to meet the growing demand for mobile broadband access, but to advance and enhance the user experience with mobile communications.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In various aspects, the disclosure provides for one or more enhancements to the provision of results to a user's request for a manual scan for a new public land mobile network (PLMN). For example, a UE may be provided with a capability to implement a partial PLMN scan, providing quick results to a user's request for a manual PLMN scan, in a way that is expedited relative to the conventional method of providing PLMN results only when a full scan is completed. In further aspects, the disclosure provides for various optimizations to expedite a PLMN scan, which may be implemented either with the partial PLMN scan, or in a full PLMN scan, to further expedite the provision of PLMN scan results to the user.

In one aspect, the disclosure provides a method of wireless communication operable at a user equipment (UE), including receiving a first request corresponding to a first subscriber identity module (SIM), to perform a public land mobile network (PLMN) scan, determining a service provider in accordance with information on the SIM, and initiating a first PLMN scan in accordance with a first band support table (BST) that includes a service provider field, wherein the service provider field matches the determined service provider in accordance with information on the SIM.

Another aspect of the disclosure provides a UE configured for wireless communication, including at least one processor, a memory communicatively coupled to the at least one processor, and a transceiver communicatively coupled to the at least one processor. Here, the at least one processor is configured to receive a first request corresponding to a first SIM, to perform a PLMN scan, to determine a service provider in accordance with information on the SIM, and to initiate a first PLMN scan in accordance with a first BST that includes a service provider field, wherein the service provider field matches the determined service provider in accordance with information on the SIM.

Another aspect of the disclosure provides a non-transitory computer-readable storage medium that includes instructions for causing a computer to receive a first request corresponding to a first SIM, to perform a PLMN scan, to determine a service provider in accordance with information on the SIM, and to initiate a first PLMN scan in accordance with a first BST that includes a service provider field, wherein the service provider field matches the determined service provider in accordance with information on the SIM.

Another aspect of the disclosure provides a UE configured for wireless communication, including means for receiving a first request corresponding to a first SIM, to perform a PLMN scan, means for determining a service provider in accordance with information on the SIM, and means for initiating a first PLMN scan in accordance with a first BST that includes a service provider field, wherein the service provider field matches the determined service provider in accordance with information on the SIM.

These and other aspects of the invention will become more fully understood upon a review of the detailed description, which follows. Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a block diagram illustrating an example of a hardware implementation for an apparatus employing a processing system.

FIG. 2 is a block diagram conceptually illustrating an example of a telecommunications system.

FIG. 3 is a conceptual diagram illustrating an example of an access network.

FIG. 4 is a conceptual diagram illustrating an example of a radio protocol architecture for the user and control plane.

FIG. 5 is a block diagram conceptually illustrating an example of a Node B in communication with a UE in a telecommunications system.

FIG. 6 is a flow chart illustrating a process of implementing a partial PLMN scan according to one example.

FIG. 7 is a flow chart illustrating a process of implementing an expedited PLMN scan according to one example.

FIG. 8 is a flow chart illustrating a process of implementing a manual PLMN scan when a user initiates multiple manual PLMN scan requests in a short period of time, according to one example.

FIG. 9 is a flow chart illustrating a process of implementing a manual PLMN scan when a user requests a second manual PLMN scan corresponding to a different SIM than that of the first request in a given time since a first manual PLMN scan request, according to one example.

FIG. 10 is a flow chart illustrating a process of automatic updates to a band support table (BST) according to one example.

FIG. 11 is a flow chart illustrating a process of aborting a manual PLMN scan according to one example.

FIG. 12 is a flow chart illustrating a process of implementing a manual PLMN scan utilizing an acquisition database according to one example.

FIG. 13 is a flow chart illustrating a process of implementing a two-stage manual PLMN scan according to one example.

FIG. 14 is a flow chart illustrating a process of implementing a manual PLMN scan in a semi-background fashion according to one example.

FIG. 15 is a flow chart illustrating a process of utilizing information in system information blocks (SIBs) to alter a manual PLMN scan according to one example.

FIG. 16 is a flow chart illustrating a process of implementing an expedited PLMN scan according to one example for China deployment.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

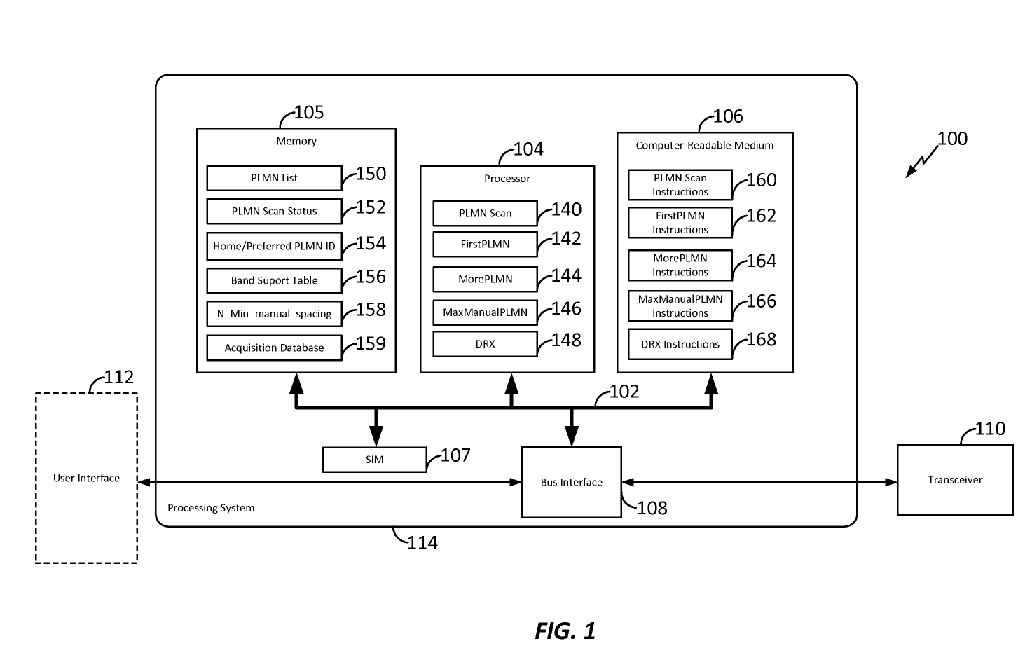

FIG. 1 is a conceptual diagram illustrating an example of a hardware implementation for a user equipment (UE) 100 employing a processing system 114. In accordance with various aspects of the disclosure, an element, or any portion of an element, or any combination of elements may be implemented with a processing system 114 that includes one or more processors 104. Examples of processors 104 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors (represented generally by the processor 104), a memory 105, computer-readable media (represented generally by the computer-readable medium 106), and a subscriber identity module (SIM) 107. The SIM 107 may store various information relating to a subscriber identity, including but not limited to subscriber-specific information, home PLMN (HPLMN) information, etc. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The memory 105 may include a PLMN list 150 for storing a list of identified PLMNs, as described in further detail below. The PLMN list 150 may further be updated one or more times during a PLMN scan. The memory 105 may further include PLMN scan status information 152. The PLMN scan status 152 may include one or more flags, including but not limited to a flag for indicating whether the full manual PLMN scan is completed; a flag for indicating whether the current list of PLMNs in the PLMN list 150 is a partial list; etc. The memory 105 may further include a home/preferred PLMN ID field 154 for storing one or both of a home PLMN (HPLMN) and/or a preferred PLMN ID for expediting partial and/or full PLMN scans. The memory 105 may further include a band support table (BST) 156 for storing a list of supported bands, radio access technologies (RATs), PLMN IDs, etc., for use in a PLMN scan as described further below. The memory 105 may further include values for initializing one or more timers, including but not limited to N_Min_manual_spacing 158, as described further below. The memory 105 may further include an acquisition database 159 for storing a list of frequency channels and systems that have been acquired previously by the UE 100. This acquisition database (ACQ DB) may be updated by the UE 100 from time to time, e.g., when the UE 100 acquires service utilizing a new channel or system.

The processor 104 may include a PLMN scanner 140. The PLMN scanner 140 may be communicatively coupled with one or more functional entities such as the transceiver 110 to scan the air interface, including one or more bands and/or one or more RATs to attempt to identify available PLMNs. The processor 104 may further include one or more timers, including a FirstPLMN timer 142, a MorePLMN timer 144, and a MaxManualPLMN timer 146, each configured to measure an amount of time for certain time-based functions, described in further detail below. The processor 104 may further include a DRX entity 148. The DRX entity 140 may be communicatively coupled with one or more functional entities such as the transceiver 110 to enable discontinuous reception functionality, described in further detail below.

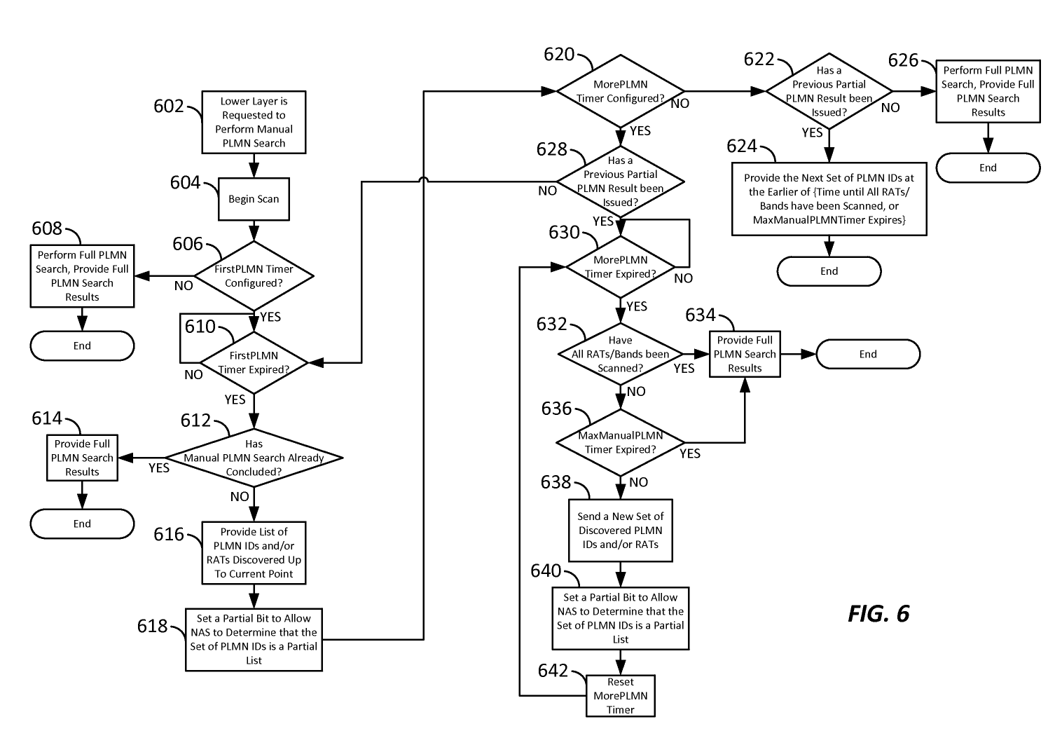

The processor 104 is further responsible for managing the bus 102 and general processing, including the execution of software stored on the computer-readable medium 106. That is, the processing system 114, including the processor 104, may be used to implement any one of the methods disclosed herein, such as those illustrated in FIGS. 6, 7, 8, 9, 10, 11, 12, 13, 14, 15, and/or 16. The computer-readable medium 106 may also be used for storing data that is manipulated by the processor 104 when executing software, and the software may be configured to implement any one of the methods disclosed herein, such as those illustrated in FIGS. 6, 7, 8, 9, 10, 11, 12, 13, 14, 15, and/or 16.

One or more processors 104 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 106. The computer-readable medium 106 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium 106 may reside in the processing system 114, external to the processing system 114, or distributed across multiple entities including the processing system 114. The computer-readable medium 106 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In some examples, the computer-readable medium 106 may include PLMN scan instructions 160, FirstPLMN timer instructions 162, MorePLMN timer instructions 164, MaxManualPLMN timer instructions 166, and/or DRX instructions 168. These instructions may be configured to implement, in coordination with the processor 104, the functions described above in relation to the PLMN scan circuitry 140, the FirstPLMN timer circuitry 142, the MorePLMN timer circuitry 144, the MaxManualPLMN timer circuitry 146, and the DRX circuitry 148, respectively, each described above.

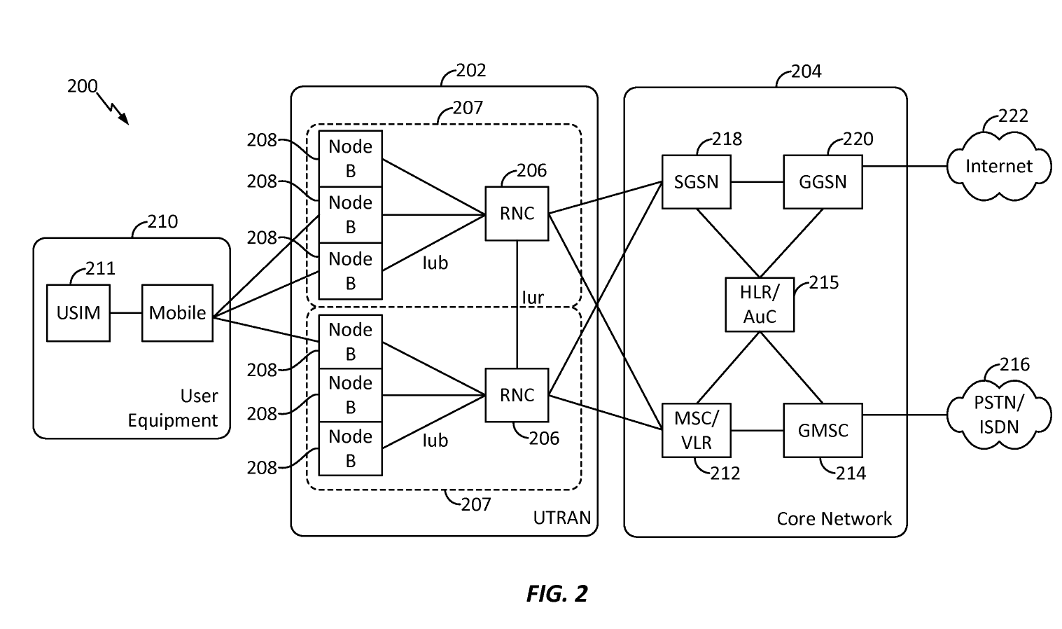

The various concepts presented throughout this disclosure may be implemented across a broad variety of telecommunication systems, network architectures, and communication standards. Referring now to FIG. 2, as an illustrative example without limitation, various aspects of the present disclosure are illustrated with reference to a Universal Mobile Telecommunications System (UMTS) system 200. A UMTS network includes three interacting domains: a core network 204, a radio access network (RAN) (e.g., the UMTS Terrestrial Radio Access Network (UTRAN) 202), and a user equipment (UE) 210. Among several options available for a UTRAN 202, in this example, the illustrated UTRAN 202 may employ a W-CDMA air interface for enabling various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the illustrated RNCs 206 and RNSs 207. The RNC 206 is an apparatus responsible for, among other things, assigning, reconfiguring, and releasing radio resources within the RNS 207. The RNC 206 may be interconnected to other RNCs (not shown) in the UTRAN 202 through various types of interfaces such as a direct physical connection, a virtual network, or the like using any suitable transport network.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provide wireless access points to a core network 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The downlink (DL), also called the forward link, refers to the communication link from a Node B 208 to a UE 210 and the uplink (UL), also called the reverse link, refers to the communication link from a UE 210 to a Node B 208.

The core network 204 can interface with one or more access networks, such as the UTRAN 202. As shown, the core network 204 is a UMTS core network. However, as those skilled in the art will recognize, the various concepts presented throughout this disclosure may be implemented in a RAN, or other suitable access network, to provide UEs with access to types of core networks other than UMTS networks.

The illustrated UMTS core network 204 includes a circuit-switched (CS) domain and a packet-switched (PS) domain. Some of the circuit-switched elements are a Mobile services Switching Centre (MSC), a Visitor Location Register (VLR), and a Gateway MSC (GMSC). Packet-switched elements include a Serving GPRS Support Node (SGSN) and a Gateway GPRS Support Node (GGSN). Some network elements, like EIR, HLR, VLR, and AuC may be shared by both of the circuit-switched and packet-switched domains.

In the illustrated example, the core network 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a visitor location register (VLR) that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The illustrated core network 204 also supports packet-switched data services with a serving GPRS support node (SGSN) 218 and a gateway GPRS support node (GGSN) 220. General Packet Radio Service (GPRS) is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

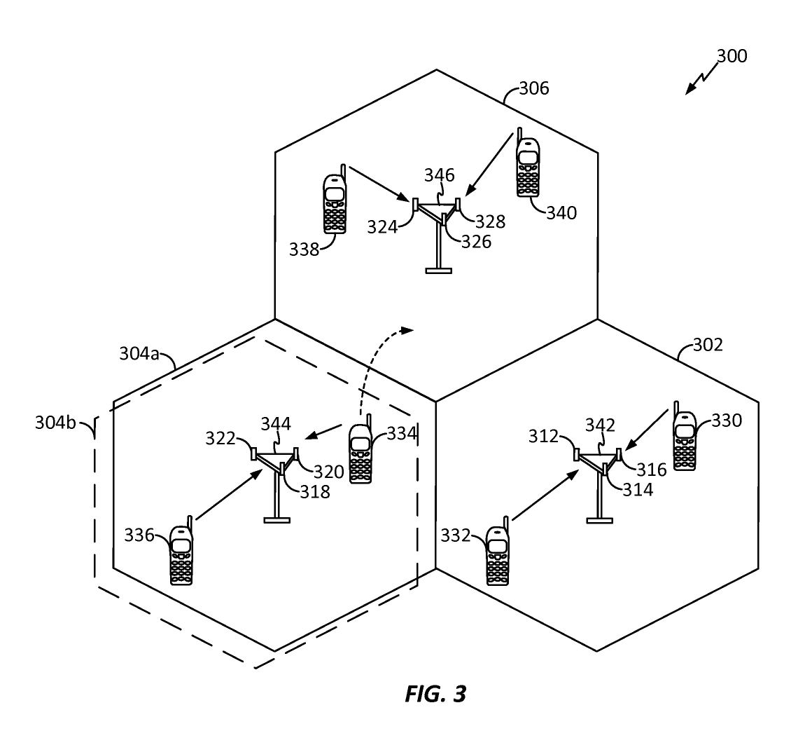

The UTRAN 202 is one example of a RAN that may be utilized in accordance with the present disclosure. Referring to FIG. 3, by way of example and without limitation, a simplified schematic illustration of a RAN 300 in a UTRAN architecture is illustrated. The system includes multiple cellular regions (cells), including cells 302, 304, and 306, each of which may include one or more sectors. Cells may be defined geographically (e.g., by coverage area) and/or may be defined in accordance with a frequency, scrambling code, etc. That is, the illustrated geographically-defined cells 302, 304, and 306 may each be further divided into a plurality of cells, e.g., by utilizing different scrambling codes. For example, cell 304a may utilize a first scrambling code, and cell 304b, while in the same geographic region and served by the same Node B 344, may be distinguished by utilizing a second scrambling code.

In a cell that is divided into sectors, the multiple sectors within a cell can be formed by groups of antennas with each antenna responsible for communication with UEs in a portion of the cell. For example, in cell 302, antenna groups 312, 314, and 316 may each correspond to a different sector. In cell 304, antenna groups 318, 320, and 322 may each correspond to a different sector. In cell 306, antenna groups 324, 326, and 328 may each correspond to a different sector.

The cells 302, 304, and 306 may include several UEs that may be in communication with one or more sectors of each cell 302, 304, or 306. For example, UEs 330 and 332 may be in communication with Node B 342, UEs 334 and 336 may be in communication with Node B 344, and UEs 338 and 340 may be in communication with Node B 346. Here, each Node B 342, 344, and 346 may be configured to provide an access point to a core network 204 (see FIG. 2) for all the UEs 330, 332, 334, 336, 338, and 340 in the respective cells 302, 304, and 306.

During a call with a source cell, or at any other time, the UE 336 may monitor various parameters of the source cell as well as various parameters of neighboring cells. Further, depending on the quality of these parameters, the UE 336 may maintain communication with one or more of the neighboring cells. During this time, the UE 336 may maintain an Active Set, that is, a list of cells to which the UE 336 is simultaneously connected (i.e., the UTRAN cells that are currently assigning a downlink dedicated physical channel DPCH or fractional downlink dedicated physical channel F-DPCH to the UE 336 may constitute the Active Set).

The UTRAN air interface may be a spread spectrum Direct-Sequence Code Division Multiple Access (DS-CDMA) system, such as one utilizing the W-CDMA standards. The spread spectrum DS-CDMA spreads user data through multiplication by a sequence of pseudorandom bits called chips. The W-CDMA air interface for the UTRAN 202 is based on such DS-CDMA technology and additionally calls for a frequency division duplexing (FDD). FDD uses a different carrier frequency for the uplink (UL) and downlink (DL) between a Node B 208 and a UE 210. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles are equally applicable to a TD-SCDMA air interface or any other suitable air interface.

A high speed packet access (HSPA) air interface includes a series of enhancements to the 3G/W-CDMA air interface between the UE 210 and the UTRAN 202, facilitating greater throughput and reduced latency for users. Among other modifications over prior standards, HSPA utilizes hybrid automatic repeat request (HARQ), shared channel transmission, and adaptive modulation and coding. The standards that define HSPA include HSDPA (high speed downlink packet access) and HSUPA (high speed uplink packet access, also referred to as enhanced uplink or EUL).

In a wireless telecommunication system, the communication protocol architecture may take on various forms depending on the particular application. For example, in a 3GPP UMTS system, the signaling protocol stack is divided into a Non-Access Stratum (NAS) and an Access Stratum (AS). The NAS provides the upper layers, for signaling between the UE 210 and the core network 204 (referring to FIG. 2), and may include circuit switched and packet switched protocols. The AS provides the lower layers, for signaling between the UTRAN 202 and the UE 210, and may include a user plane and a control plane. Here, the user plane or data plane carries user traffic, while the control plane carries control information (i.e., signaling).

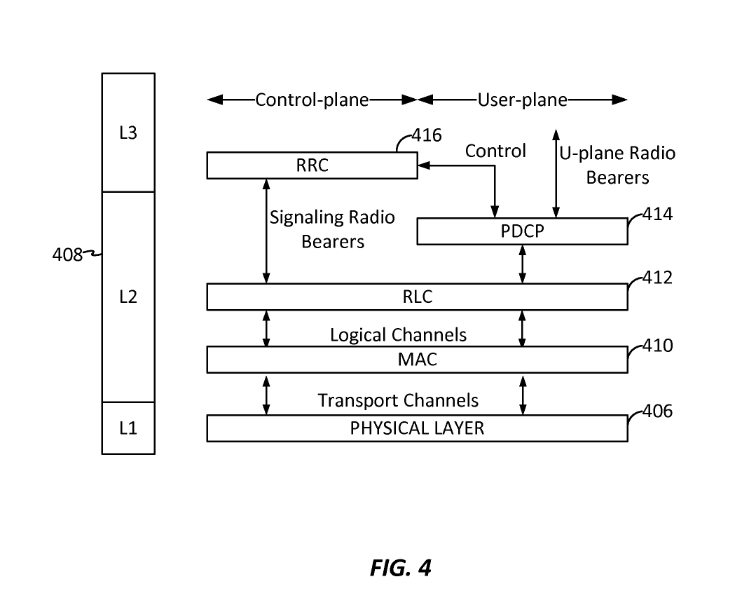

Turning to FIG. 4, the AS is shown with three layers: Layer 1, Layer 2, and Layer 3. Layer 1 is the lowest layer and implements various physical layer signal processing functions. Layer 1 will be referred to herein as the physical layer 406. The data link layer, called Layer 2 408, is above the physical layer 406 and is responsible for the link between the UE 210 and Node B 208 over the physical layer 406.

At Layer 3, the RRC layer 416 handles the control plane signaling between the UE 210 and the Node B 208. RRC layer 416 includes a number of functional entities for routing higher layer messages, handling broadcasting and paging functions, establishing and configuring radio bearers, etc.

In the illustrated air interface, the L2 layer 408 is split into sublayers. In the control plane, the L2 layer 408 includes two sublayers: a medium access control (MAC) sublayer 410 and a radio link control (RLC) sublayer 412. In the user plane, the L2 layer 408 additionally includes a packet data convergence protocol (PDCP) sublayer 414. Although not shown, the UE may have several upper layers above the L2 layer 408 including a network layer (e.g., IP layer) that is terminated at a PDN gateway on the network side and an application layer that is terminated at the other end of the connection (e.g., far end UE, server, etc.).

The PDCP sublayer 414 provides multiplexing between different radio bearers and logical channels. The PDCP sublayer 414 also provides header compression for upper layer data packets to reduce radio transmission overhead, security by ciphering the data packets, and handover support for UEs between Node Bs.

The RLC sublayer 412 generally supports an acknowledged mode (AM) (where an acknowledgment and retransmission process may be used for error correction), an unacknowledged mode (UM), and a transparent mode for data transfers, and provides segmentation and reassembly of upper layer data packets and reordering of data packets to compensate for out-of-order reception due to a hybrid automatic repeat request (HARQ) at the MAC layer. In the acknowledged mode, RLC peer entities such as an RNC and a UE may exchange various RLC protocol data units (PDUs) including RLC Data PDUs, RLC Status PDUs, and RLC Reset PDUs, among others. In the present disclosure, the term “packet” may refer to any RLC PDU exchanged between RLC peer entities.

The MAC sublayer 410 provides multiplexing between logical and transport channels. The MAC sublayer 410 is also responsible for allocating the various radio resources (e.g., resource blocks) in one cell among the UEs. The MAC sublayer 410 is also responsible for HARQ operations.

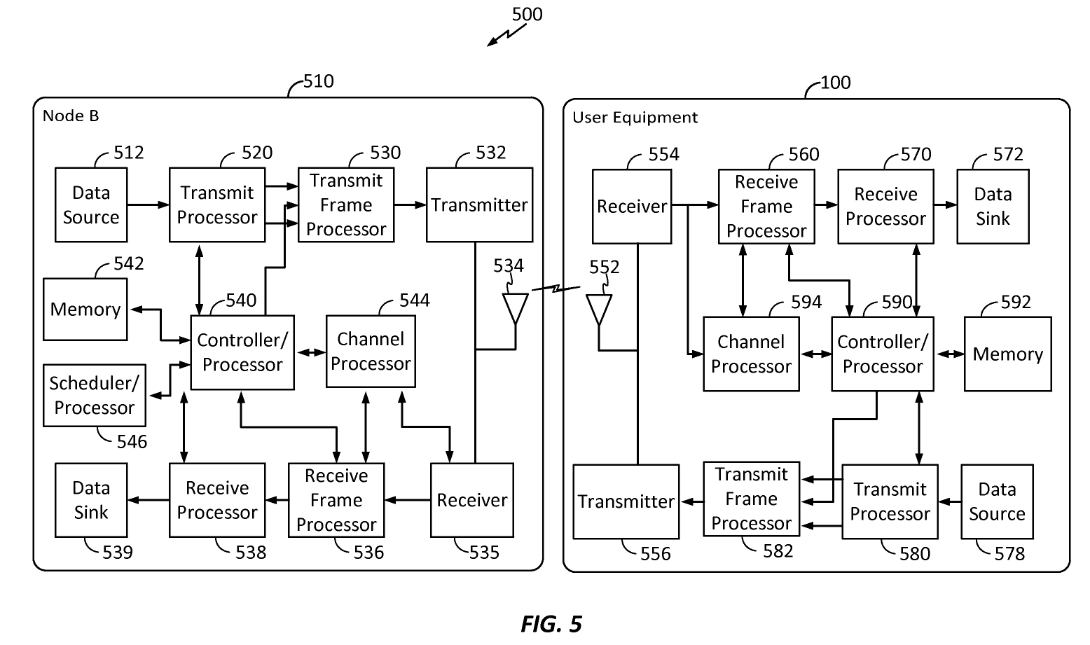

FIG. 5 is a block diagram of an exemplary Node B 510 in communication with an exemplary UE 100, where the Node B 510 may be the Node B 208 in FIG. 2, and the UE 100 may be the UE 210 in FIG. 2. In the downlink communication, a transmit processor 520 may receive data from a data source 512 and control signals from a controller/processor 540. The transmit processor 520 provides various signal processing functions for the data and control signals, as well as reference signals (e.g., pilot signals). For example, the transmit processor 520 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 544 may be used by a controller/processor 540 to determine the coding, modulation, spreading, and/or scrambling schemes for the transmit processor 520. These channel estimates may be derived from a reference signal transmitted by the UE 100 or from feedback from the UE 100. The symbols generated by the transmit processor 520 are provided to a transmit frame processor 530 to create a frame structure. The transmit frame processor 530 creates this frame structure by multiplexing the symbols with information from the controller/processor 540, resulting in a series of frames. The frames are then provided to a transmitter 532, which provides various signal conditioning functions including amplifying, filtering, and modulating the frames onto a carrier for downlink transmission over the wireless medium through antenna 534. The antenna 534 may include one or more antennas, for example, including beam steering bidirectional adaptive antenna arrays or other similar beam technologies.

At the UE 100, a receiver 554 receives the downlink transmission through an antenna 552 and processes the transmission to recover the information modulated onto the carrier. The information recovered by the receiver 554 is provided to a receive frame processor 560, which parses each frame, and provides information from the frames to a channel processor 594 and the data, control, and reference signals to a receive processor 570. The receive processor 570 then performs the inverse of the processing performed by the transmit processor 520 in the Node B 510. More specifically, the receive processor 570 descrambles and despreads the symbols, and then determines the most likely signal constellation points transmitted by the Node B 510 based on the modulation scheme. These soft decisions may be based on channel estimates computed by the channel processor 594. The soft decisions are then decoded and deinterleaved to recover the data, control, and reference signals. The CRC codes are then checked to determine whether the frames were successfully decoded. The data carried by the successfully decoded frames will then be provided to a data sink 572, which represents applications running in the UE 100 and/or various user interfaces (e.g., display). Control signals carried by successfully decoded frames will be provided to a controller/processor 590. When frames are unsuccessfully decoded by the receiver processor 570, the controller/processor 590 may also use an acknowledgement (ACK) and/or negative acknowledgement (NACK) protocol to support retransmission requests for those frames.

In the uplink, data from a data source 578 and control signals from the controller/processor 590 are provided to a transmit processor 580. The data source 578 may represent applications running in the UE 100 and various user interfaces (e.g., keyboard). Similar to the functionality described in connection with the downlink transmission by the Node B 510, the transmit processor 580 provides various signal processing functions including CRC codes, coding and interleaving to facilitate FEC, mapping to signal constellations, spreading with OVSFs, and scrambling to produce a series of symbols. Channel estimates, derived by the channel processor 594 from a reference signal transmitted by the Node B 510 or from feedback contained in the midamble transmitted by the Node B 510, may be used to select the appropriate coding, modulation, spreading, and/or scrambling schemes. The symbols produced by the transmit processor 580 will be provided to a transmit frame processor 582 to create a frame structure. The transmit frame processor 582 creates this frame structure by multiplexing the symbols with information from the controller/processor 590, resulting in a series of frames. The frames are then provided to a transmitter 556, which provides various signal conditioning functions including amplification, filtering, and modulating the frames onto a carrier for uplink transmission over the wireless medium through the antenna 552.

The uplink transmission is processed at the Node B 510 in a manner similar to that described in connection with the receiver function at the UE 100. A receiver 535 receives the uplink transmission through the antenna 534 and processes the transmission to recover the information modulated onto the carrier. The information recovered by the receiver 535 is provided to a receive frame processor 536, which parses each frame, and provides information from the frames to the channel processor 544 and the data, control, and reference signals to a receive processor 538. The receive processor 538 performs the inverse of the processing performed by the transmit processor 580 in the UE 100. The data and control signals carried by the successfully decoded frames may then be provided to a data sink 539 and the controller/processor, respectively. If some of the frames were unsuccessfully decoded by the receive processor, the controller/processor 540 may also use an acknowledgement (ACK) and/or negative acknowledgement (NACK) protocol to support retransmission requests for those frames.

The controller/processors 540 and 590 may be used to direct the operation at the Node B 510 and the UE 100, respectively. For example, the controller/processors 540 and 590 may provide various functions including timing, peripheral interfaces, voltage regulation, power management, and other control functions. The computer readable media of memories 542 and 592 may store data and software for the Node B 510 and the UE 100, respectively. A scheduler/processor 546 at the Node B 510 may be used to allocate resources to the UEs and schedule downlink and/or uplink transmissions for the UEs.

As briefly discussed above, when operating in a wireless communication network, a UE such as the UE 100 is generally enabled to establish voice communication with another user by way of a public land mobile network (PLMN). Each PLMN is identified by a unique PLMN ID, which generally includes a mobile country code (MCC) and a mobile network code (MNC). The MCC generally identifies the country in which the PLMN is located, and the MNC generally identifies the service provider or operator for that PLMN.

In many cases, there is more than one PLMN that a user can utilize for service at a given time and location. In such a case, a user may wish to select which PLMN to utilize for service. Thus, it may be enabled for the user, e.g., utilizing the user interface (UI), to manually initiate a PLMN scan.

When a UE receives a request from its user to initiate such a manual PLMN scan, in some implementations the UE may scan across a plurality of bands, and scan across a plurality of radio access technologies (RATs), to gather available PLMN information. Here, RATs refer to the air interface for a wireless communication system, with one example being the W-CDMA air interface described above in connection with the UTRAN, although other examples of RATs abound, including but not limited to the TD-SCDMA air interface in connection with the UTRAN, GSM, LTE, cdma2000, EV-DO, etc.

In response to the user initiation of the manual PLMN scan, a list of PLMNs may be provided to the user, e.g., by displaying the list on the user interface. In this way, the user can be enabled to select one of the listed PLMNs for service. Here, in response to the manual PLMN scan request, a UE might only provide a list of the detected PLMNs after completing the scan of all of the RATs and bands. However, waiting until after all RATs and bands are scanned can lead to a large delay before the UE can provide the resulting list of PLMNs.

Therefore, in accordance with an aspect of the present disclosure, a UE 100 may be enabled to improve the manual PLMN scan procedure, resulting in faster provision of the list of detected PLMNs to the user.

In accordance with another aspect of the present disclosure, a UE 100 may be enabled to provide partial PLMN scam results to the user, e.g., without completing the entire scan of all RATs and bands, such that an expedited, although partial, list of PLMNs may be provided to the user.

Partial PLMN Scan

As indicated above, in some aspects of the disclosure, the UE 100 may be configured to perform a partial PLMN scan in response to a user request for a manual PLMN scan. In a general sense, a partial PLMN scan may provide the set of PLMNs discovered in the first X minutes, and update the list every Y minutes as more PLMNs are discovered. Here, the PLMN scan activity may continue as long as needed, eventually resulting in full PLMN scan results being provided to the user.

While this broad algorithm could result in quicker PLMN scan results that are usable, it presents a number of issues. For example, providing such a partial PLMN list may result in inconsistent results, when compared to other UEs that might display all PLMNs after a full scan. Further, if the PLMN that would be the most preferred PLMN does not appear in the partial list presented at any given time, the user may select a less preferred PLMN, resulting in reduced quality or other issues with the service.

Additionally, when PLMNs are provided in batches (e.g., wherein the PLMN list is updated every n seconds with results obtained up to that time), it may not be possible for the UE to re-order the listed PLMNs, according to the priority rules in the PLMN database files. Moreover, there may be a general desire to avoid excessive interaction between applications and the modem.

Thus, various aspects of the present disclosure provide a partial PLMN scan method and algorithm that enables expedited PLMN scan results, in a way that may address one or more of the above issues.

In one example, a UE 100 may be configured to support a set of parameters, which may act as configuration timers. These may include FirstPLMN, MorePLMN, and MaxManualPLMN timers. These are described in further detail below in connection with FIG. 6.

In the algorithm that follows, and in the present disclosure, the term “PLMN scan” is intended broadly to include a search across one or more bands, and/or one or more RATs, for PLMNs with which the UE 100 may have the capability to communicate.

FIG. 6 is a flow chart illustrating an exemplary process 600 of implementing a partial PLMN scan in accordance with an aspect of the disclosure. In some examples, the process 600 may be implemented by the UE 100. In some examples, the process 600 may be implemented by a suitably configured processor 104 or any other suitable means for performing the functions recited below.

At block 602, a lower layer at the UE 100 may be requested to perform a manual PLMN scan. For example, a user in possession and/or control of the UE 100 may utilize a user interface 112 to request an operating system, an application, or another suitable upper layer (e.g., application layer) entity at the UE 100 to perform a PLMN scan, and this upper layer entity may provide information corresponding to this request to a lower layer at the UE 100, e.g., the physical layer 406 and/or the MAC layer 410. In response, at block 604, the UE 100 may begin the PLMN scan.

At block 606, the UE 100 may determine whether the FirstPLMN timer 142 is configured. Here, the FirstPLMN timer 142 may be utilized to determine the time when the first partial set of PLMN scan results are provided. If the FirstPLMN timer 142 is not configured, then at block 608 the UE 100 may perform a full PLMN scan, providing the full PLMN scan results to the user (e.g., utilizing the user interface 112) once the scan is complete.

On the other hand, if in accordance with an aspect of the present disclosure the FirstPLMN timer 142 is configured, then at block 610 the UE 100 may wait a suitable duration of time until the FirstPLMN timer 142 expires. After expiration of the FirstPLMN timer 142, at block 612, at the UE 100 may determine whether the manual PLMN scan has been already completed (e.g., corresponding to the PLMN scan status information element 152). If the scan is already complete, there is no need to deliver partial results, and thus, at block 614 the UE 100 may provide the full PLMN scan results. On the other hand, if the search is not yet complete, then at block 616, in an aspect of the present disclosure, the UE 100 may provide a partial list of PLMN IDs and/or RATs discovered up to the current point in the PLMN scan.

In a further aspect of the disclosure, at block 618, the UE 100 may set a “partial” bit or flag, e.g., in an application programming interface (API) callback routine (which may correspond to the PLMN scan status information element 152), to enable the NAS to determine that the set of PLMN IDs in the list provided in block 616 is a partial PLMN list.

Upon the provision of the first partial PLMN list, in a further aspect of the disclosure, the process 600 may proceed to iterative updating of the partial PLMN list, e.g., utilizing the MorePLMN timer 144.

That is, at block 620, the UE 100 may determine if the MorePLMN timer 144 is configured. If it is not configured, but at block 622 the UE 100 determines that a previous partial PLMN result has been issued (e.g., corresponding to the PLMN scan status information element 152), then at block 624 the UE 100 may update the PLMN list 150 to provide the next set of PLMN IDs, updating the partial list at the earlier of: the time when all RATs and/or bands have been scanned (e.g., when the PLMN scan status information element 152 indicates that the PLMN scan is complete), or the time that a MaxManualPLMN timer 146 expires. The MaxManualPLMN timer 146 is described in further detail below. On the other hand, if at block 622 the UE 100 determines that no previous partial PLMN result has been issued (e.g., corresponding to the PLMN scan status information element 152), then at block 626 the UE 100 may continue the PLMN scan until complete, and provide full PLMN scan results upon completion.

Returning to block 620, if the MorePLMN timer 144 is configured, then at block 628, the UE 100 may determine whether a previous partial PLMN result has been issued (e.g., corresponding to the PLMN scan status information element 152). Here, if no previous partial PLMN result has been issued, in one example the process 600 may return to block 610 (or any other suitable stage in the generation of the first partial PLMN list) to generate the first partial list of PLMN IDs. If a previous partial PLMN result has been issued, then at block 630 the UE 100 may wait for the MorePLMN timer 144 to expire, and after the MorePLMN timer 144 expires, at block 632, the UE 100 may determine whether all RATs and/or bands have been scanned (e.g., according to the PLMN scan status information element 152). If the scan is complete, then at block 634 the UE 100 may provide to the user the full PLMN scan results, as stored in the PLMN list 150. In one example, here, if a “partial” bit has been set at the PLMN scan status information element 152, this bit may be cleared to indicate that this list is no longer a partial list.

On the other hand, if at block 632 the UE 100 determines that not all RATs and/or bands have been scanned, then at block 636 the UE 100 may determine whether the MaxManualPLMN timer 146 has expired. Here, the MaxManualPLMN timer 146 may be utilized to implement a maximum time for updating the partial PLMN list 150. In some examples, a value of about 2 minutes may be utilized for the MaxManualPLMN timer 146. If the MaxManualPLMN timer 146 has expired, then at block 634, the UE 100 may provide the full PLMN scan results list 150 as found up until this time. However, if the MaxManualPLMN timer 146 has not yet expired, then at block 638 the UE 100 may deliver to the user of the UE 100 a new set of discovered PLMN IDs and/or RATs, as an update to the partial list.

In a further aspect of the disclosure, at block 640, the UE 100 may set the “partial” bit of the PLMN scan status information element 152, to allow the NAS to determine that the set of PLMN IDs provided at block 638 is a partial list.

At block 642, the UE 100 may reset the MorePLMN timer 144, and the process may return to block 630 to wait for the MorePLMN timer 144 to expire for a next iteration and update of the partial PLMN list 150.

In a further aspect of the disclosure, the NAS (e.g., any higher layer at the UE 100 configured to communicate with the core network 204, including but not limited to protocol layers above the L3 layer in FIG. 4, such as an application layer) may store all of the PLMN IDs it has received from the lower layers according to the partial PLMN scan described above, until it receives a result that does not have the “partial” API bit set at the PLMN scan status information element 152. When the NAS at the UE 100 does receive a set of PLMN scan results with the “partial” API bit set, the NAS may place all of the PLMN IDs received up until that point in a certain order, based on the priority rules for PLMN selection defined at 3GPP TS 23.122 (Non-Access-Stratum (NAS) functions related to Mobile Station (MS) in idle mode), incorporated herein by reference, or according to any suitable set of priority rules for PLMN selection. Further, the UE 100 may provide the ordered list to the user interface 112 along with a flag (e.g., utilizing the PLMN scan status information element 152), indicating that the manual PLMN scan results are in fact partial results. In this way, wherein the UE 100 may collate multiple partial PLMN results, the UE 100 may avoid a problem case wherein the results are ordered incorrectly when they are presented to the user over the user interface 112.

### Manual PLMN Scan Speed-Up

In a further aspect of the disclosure, one or more approaches are provided to expedite the PLMN scan process. The approaches described herein below may be applied to the partial PLMN scan algorithm, described above, or in other examples, may be applied to a full PLMN scan.

In some manual PLMN scans, the UE may scan all the bands and RATs that it supports. However, in any given country, for example, only certain bands and RATs will be deployed. Therefore, according to an aspect of the disclosure, if a UE 100 knows its current country of operation, a manual PLMN scan may be completed more quickly by focusing on the bands and RATs that are known to be deployed in that country.

In the partial PLMN scan described above, where results are displayed relatively quickly, in order to minimize the probability that the user may select a less-preferred PLMN, in an aspect of the present disclosure, the UE 100 may attempt to find its home PLMN ID and its preferred PLMN ID(s) first. In this way, if the UE 100 knows the bands and/or RATs in which the home PLMN ID is listed, the UE 100 can prioritize these bands and/or RATs first in its search.

To this end, in some aspects of the present disclosure, the UE 100 may utilize a band support table (BST) 156 as described below.

Table 1 below illustrates the format of a BST according to one example. Here, the BST includes MCC-level specification for bands and RATs, and one default MCC for the rest of the world. That is, if an MCC corresponding to the current location of the UE 100 is known, a PLMN scan may be limited to bands and/or RATs listed in the BST that correspond to that MCC. However, if the current location's MCC is unknown, or if the current location's MCC is not one of the MCCs listed in the BST, then a PLMN scan may utilize the default band/RAT list shown in the illustrated exemplary BST.

TABLE 1

MCC_INCL =0 (default band list)

RAT1 (LTE) : Band X, Band Y
RAT2 (UMTS) : Band A, Band B, Band C, Band D
RAT3 (GSM) : GSM900, GSM 800, GSM 1900, GSM 1800

MCC_INCL =1, MCC1 (home country)

PLMN-ID = * (LTE) : Band X, Band Y
PLMN-ID = * (UMTS) : Band U1, Band U2
PLMN-ID = * (GSM) : Band G1, Band G2

In an aspect of the present disclosure, the UE 100 may store a BST 156 that includes one or more additional fields beyond those described above. Table 2 below illustrates an exemplary BST 156 according to one aspect of the disclosure, wherein newly added fields are in red text, and include a service provider ID field and a supplemental PLMN ID field.

TABLE 2

Service provider ID =PLMN1

MCC_INCL =0 (default band list)

RAT1 (LTE) : Band X, Band Y
RAT2 (UMTS) : Band A, Band B, Band C, Band D
RAT3 (GSM) : GSM900, GSM 800, GSM 1900, GSM 1800

MCC_INCL =1, MCC1 (home country)

PLMN-ID = PLMN1 (LTE) : Band X
PLMN-ID = * (LTE) : Band X, Band Y
PLMN-ID = * (UMTS) : Band U1, Band U2
PLMN-ID = * (GSM) : Band G1, Band G2

Here, the service provider ID field may enable multiple BSTs to be stored in the UE 100, e.g., to account for an open market handset. That is, a suitable BST may be selected from a plurality of stored BSTs in accordance with which service provider is identified on the SIM card 107 inserted into a particular handset or UE 100. In this way, when the SIM 107 is switched out, such as when a user changes their subscription to a new service provider, the UE 100 may be configured to select a different BST, including the service provider ID field that identifies the home PLMN corresponding to the service provider identified in the new SIM.

For example, in an aspect of the disclosure, the UE 100 may support a BST per service provider, by utilizing the service provider ID field described above. That is, service provider information may be encoded as a service provider ID field in the BST 156, in a backwards-compatible manner. In this way, support may be provided for a use case wherein the UE 100 is an open market handset. That is, by being provisioned with a plurality of BSTs corresponding to a plurality of major operators or service providers, the UE 100 may have one prioritized band list for each major operator. Thus, when one or more such BSTs are provisioned on the UE 100, the UE 100 can choose the correct BST to utilize based on the E-HPLMN in the SIM 107 being used by the open market handset.

Thus, when a user, e.g., using the user interface 112, issues a manual PLMN scan request, the UE 100 may check whether there exists a 3GPP BST 156 that has the service provider ID equal to the UE's home PLMN ID, according to the SIM credentials. If there is such a BST, the UE 100 may utilize that BST 156 and perform a PLMN scan according to the prioritized band list in that BST. On the other hand, if the UE 100 is not provisioned with such a BST, a default BST (e.g., one without a service provider ID) may be utilized.

Further, the supplemental PLMN ID field, indicated in red in Table 2, may specify bands and/or RATs to be scanned per PLMN ID. For example, a PLMN ID in a supplemental PLMN ID field may correspond to a home PLMN for the UE 100. In this way, the UE 100 may be enabled to focus its initial PLMN scans initially on its home PLMN in the partial PLMN scan. That is, the UE 100 may initially scan the one or more bands and/or RATs corresponding to its home PLMN, by referencing this supplemental PLMN ID field.

In a still further example, the BST 156 may include channel-level information for each MCC or PLMN of interest. That is, referring to Table 2 above, additional information elements indicating known channels corresponding to one or more MCCs, and/or one or more PLMNs, may be included in the BST 156. In this way, manual PLMN scans may be completed even more quickly, by narrowing the PLMN scan to known channels.

In a still further example, the BST 156 may include bands of interest per tracking area, in order to enable focusing the scans on a much smaller set of bands and RATs, based on the current location of the UE 100. That is, referring to Table 2 above, additional information elements including known bands to search, corresponding to one or more determined locations, may be included in the BST 156.

In a further aspect of the disclosure, if the UE 100 is provisioned with the modified BST 156 described above, the UE 100 may utilize the current mobile country code (MCC) of operation to determine which BST record to utilize. That is, if a BST record exists for the current MCC, and this record lists the most preferred PLMN ID in the current MCC, then the bands and/or RATs associated with that PLMN ID may be scanned first, before scanning the remaining bands and/or RATs in the BST.

However, if a record exists for the current MCC but it does not list the most preferred PLMN ID in the current MCC, then the UE 100 may scan the bands and/or RATs associated with the default record for that MCC (i.e., PLMN-ID=* in Table 2).

Moreover, if no record exists for the current MCC, or if the current MCC cannot be determined (e.g., if the UE 100 is out of service when the scan was issued), then the UE 100 may scan the bands and RATs associated with the default MCC record, as in the conventional case.

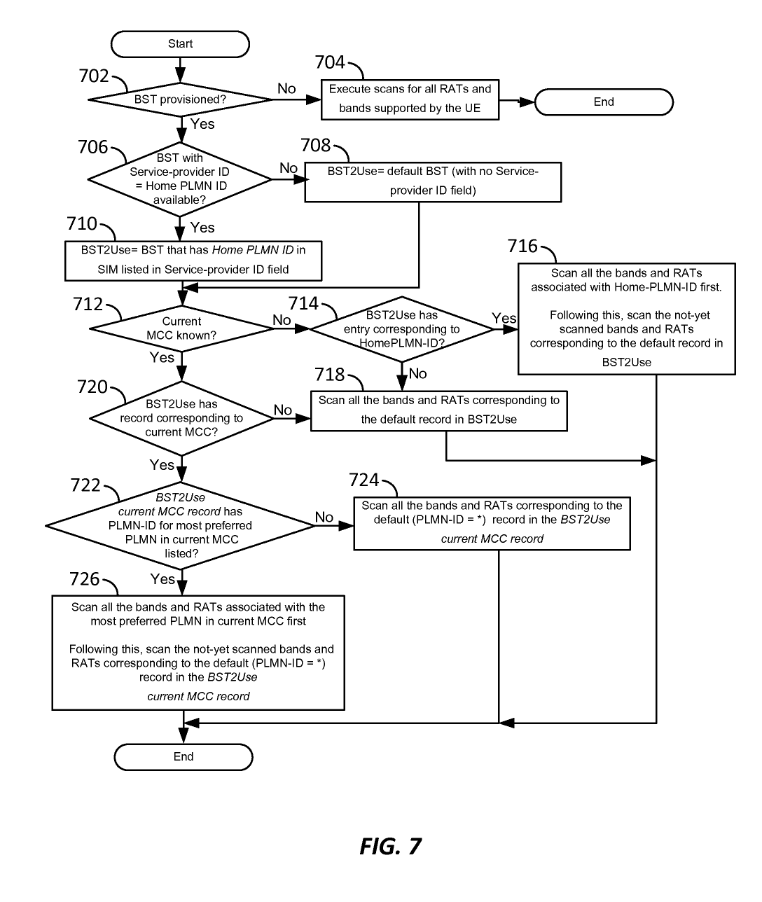

FIG. 7 is a flow chart illustrating an exemplary process 700 of utilizing the BST 156 illustrated above to expedite a PLMN scan, in accordance with one or more aspects of the disclosure. In some examples, the process may be implemented by the UE 100. In some examples, the process 700 may be implemented by a suitably configured processor 104 or any other suitable means for performing the functions recited below.

Here, the process may start upon receipt of a manual instruction from a user to initiate a manual PLMN scan. At block 702, the UE 100 may determine whether one or more BST(s) 156 have been provisioned in the UE memory 105. If no BST 156 is provisioned, then at block 704 the UE 100 may execute a PLMN scan for all RATs and/or bands that the UE 100 supports. On the other hand, if one or more BST(s) 156 have been provisioned, then at block 706, the UE 100 may determine whether any BST having a service provider ID field provisioned with a PLMN ID corresponding to the home PLMN of the UE 100, as identified in the SIM 107. If no such BST is provisioned with a service provider ID field having a PLMN corresponding to the UE's home PLMN, then at block 708 the UE 100 may set, as the BST to utilize, a default BST. Here, the default BST may be one without a service provider ID field. However, if the BST is provisioned with a service provider ID field having a PLMN corresponding to the UE's home PLMN, then at block 710 the UE may set, as the BST to utilize, the BST that is provisioned with a service provider ID field having a PLMN corresponding to the UE's home PLMN.

At block 712, the UE 100 may determine whether the MCC corresponding to the UE's current location, is known. Determination of the current MCC may be accomplished in any suitable fashion, including but not limited to reading the MCC broadcasted as a PLMN ID from any available PLMN (e.g., a first-discovered PLMN during the initial stages of a PLMN scan); determining location with other circuitry, such as a global positioning satellite (GPS) antenna circuit, and looking up within a locally stored database the MCC that corresponds to the determined location; a most recently used PLMN ID may be assumed to contain the current MCC; or any other suitable algorithm for determining the current location's MCC may be utilized. If the current MCC is not known, then at block 714 the UE 100 may determine whether a selected BST 156 has an entry including a PLMN ID corresponding to the HPLMN, as indicated in the SIM 107.

If the selected BST 156 has an entry including a PLMN ID corresponding to the HPLMN, then at block 716 the UE 100 may first scan all of the bands and/or RATs associated with the HPLMN. Following this, the UE 100 may then scan any not-yet scanned bands and/or RATs corresponding to the default record in the selected BST 156. On the other hand, if the selected BST 156 does not have an entry including a PLMN ID corresponding to the HPLMN, then at block 718 the UE 100 may scan all of the bands and/or RATs corresponding to the default record in the selected BST 156. Here, the default record refers to entries in the BST 156 that are not limited to any particular PLMN ID (e.g., referring to Table 2, records with entries including PLMN-ID=*). In this way, with the decision at block 714, the UE 100 may expedite the manual PLMN scan, in the case that the selected BST 156 has an entry including a PLMN ID corresponding to the HPLMN, by initially directing the PLMN scan to those bands and/or RATs associated with the HPLMN, but nevertheless may successfully complete a PLMN scan even if this is not the case.

Returning to block 712, if the current MCC is known, or if the UE 100 is able to determine the current MCC, then at block 720, the UE 100 may determine whether a selected BST 156 has an entry or record corresponding to the current MCC. Referring to Table 2, for example, the UE 100 may determine whether an MCC_INCL entry lists the current MCC. That is, even if the current MCC is known, if no BST has a record corresponding to that MCC, then the knowledge of the MCC is not helpful in the PLMN scan. Thus, at block 722, wherein the current MCC is known, and the selected BST 156 has an entry/record corresponding to the current MCC, the UE 100 may determine whether the current MCC record (e.g., a list of PLMN IDs including the current MCC) within the selected BST 156 has a PLMN ID corresponding a most-preferred PLMN. If the current MCC record does not include a PLMN ID corresponding to a most-preferred PLMN, then at block 724 the UE may scan all of the bands and/or RATs corresponding to the default records in the selected BST 156 corresponding to the current MCC. However, if the current MCC record includes a PLMN ID corresponding to the most-preferred PLMN, then at block 726 the UE 100 may perform a PLMN scan, first scanning all of the bands and/or RATs associated with the most-preferred PLMN in the current MCC, and following this, scanning any not-yet scanned bands and/or RATs corresponding to the default record in the selected BST 156 corresponding to the current MCC.

In this way, by looking within the BST 156 for the HPLMN at block 706, and looking within the BST 156 for a most-preferred PLMN at block 722, and prioritizing these PLMNs in the PLMN scan so that they can be scanned first, the UE 100 may be enabled to reduce or minimize a possibility that the user selects a less-preferred PLMN, which might otherwise be among the first to appear to the user in response to the user's request to perform the manual PLMN scan.

Furthermore, by limiting the PLMN scan to PLMN entries in the selected BST 156 corresponding to a currently known MCC, the PLMN scan can not only be overall more efficient, avoiding scanning for PLMNs that would not possibly exist in the current MCC, but moreover, when combined with a partial PLMN scan, as described above, may provide relevant and desirable PLMNs to the user in response to a manual PLMN scan request in an expedited fashion.

In some scenarios, it may be the case that a user attempts to initiate multiple manual PLMN scan requests in a short period of time. To address this scenario, in a further aspect of the disclosure, if a second manual PLMN scan request is issued within a certain amount of time (N_Min_manual_spacing 158, illustrated in FIG. 1) from the first request, the UE 100 may choose to forgo to implement a second search. That is, the UE 100 may ignore the repeated request.

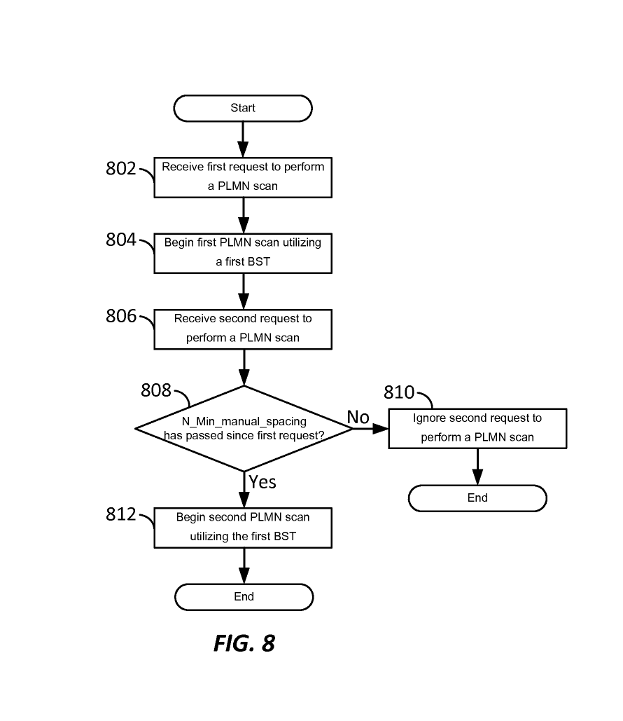

FIG. 8 is a flow chart illustrating an exemplary process 800 of implementing a manual PLMN scan when a user initiates multiple manual PLMN scan requests in a short period of time, in accordance with some aspects of the disclosure. In some examples, the process 800 may be implemented by the UE 100. In some examples, the process 800 may be implemented by a suitably configured processor 104 or any other suitable means for performing the functions recited below.

For example, the process 800 starts at block 802, wherein a user may initiate, e.g., utilizing the user interface 112, a manual PLMN scan. Thus, the UE 100 may receive a first request from the user to perform a manual PLMN scan, the scan corresponding to a first SIM (e.g., the SIM 107). At block 804, the UE 100 may accordingly initiate a first PLMN scan (e.g., utilizing the PLMN scan circuit 140 and/or PLMN scan instructions 160) in accordance with a first BST 156. In some examples, the first PLMN scan may correspond to a partial PLMN scan, with partial PLMN results being provided to the user as described above; in other examples, the first PLMN scan may correspond to a full PLMN scan.

At block 806, while the first PLMN scan is ongoing, the UE may receive a second request, to perform a second PLMN scan. For example, an impatient user may initiate a second PLMN scan due to a perceived delay in the provision of scan results. In another example, a user may initiate a second PLMN scan request corresponding to a different SIM than the SIM corresponding to the first request.

According to an aspect of the present disclosure, at block 808 the UE 100 may determine whether or not to implement a second PLMN scan corresponding to the second PLMN scan request received at block 806. For example, if the second request is received at the UE 100 within less than a predetermined interval of time from the first request received at block 802, then the UE 100 may ignore the second request, and forgo to perform the second PLMN scan. In the illustrated example in FIG. 8, if a time corresponding to the N_Min_manual_spacing timer 158 has not passed since the first request, then the process may proceed to block 810 wherein the UE 100 may ignore the second request. However, if the time corresponding to the N_Min_manual_spacing timer 158 has passed since the first request, then the process may proceed to block 812, and the UE 100 may begin the second PLMN scan.

However, in an example wherein the user requests a second manual PLMN scan corresponding to a different SIM 107 than that of the first request, but within N_Min_manual_spacing 158, in a further aspect of the disclosure, the UE 100 may scan only the bands and/or RATs that are not included in the first BST 156, during the second scan.

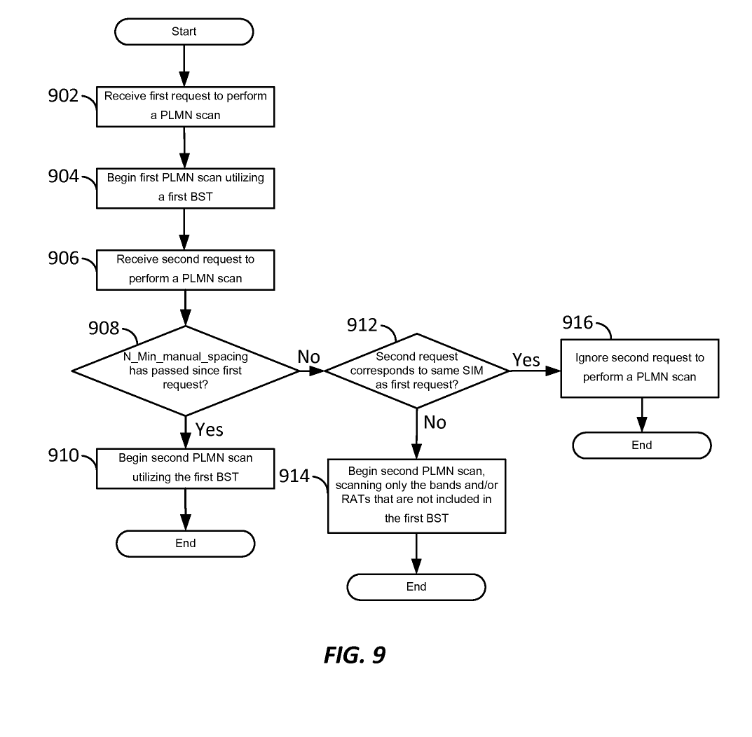

FIG. 9 is a flow chart illustrating an exemplary process 900 of implementing a manual PLMN scan when a user requests a second manual PLMN scan corresponding to a different SIM 107 than that of the first request in a given time since a first manual PLMN scan request, in accordance with some aspects of the disclosure. In some examples, the process 900 may be implemented by the UE 100. In some examples, the process 900 may be implemented by a suitably configured processor 104 or any other suitable means for performing the functions recited below.

For example, the process 900 starts at block 902, wherein a user may initiate, e.g., utilizing the user interface 112, a manual PLMN scan. Thus, the UE 100 may receive a first request from the user to perform a manual PLMN scan, the scan corresponding to a first SIM (e.g., the SIM 107). At block 904, the UE 100 may accordingly initiate a first PLMN scan (e.g., utilizing the PLMN scan circuit 140 and/or PLMN scan instructions 160) in accordance with a first BST 156. In some examples, the first PLMN scan may correspond to a partial PLMN scan, with partial PLMN results being provided to the user as described above; in other examples, the first PLMN scan may correspond to a full PLMN scan.

At block 906, while the first PLMN scan is ongoing, the UE 100 may receive a second request, to perform a second PLMN scan. For example, an impatient user may initiate a second PLMN scan due to a perceived delay in the provision of scan results. In another example, a user may initiate a second PLMN scan request corresponding to a different SIM than the SIM corresponding to the first request.

According to an aspect of the present disclosure, at blocks 908 and 912 the UE 100 may determine how to implement a second PLMN scan corresponding to the second PLMN scan request received at block 906. For example, at block 908, if the UE 100 determines that the second request is received after a predetermined interval of time from the first request received at block 902 has passed (e.g., if the N_Min_manual_spacing timer 158 has expired), then the process may proceed to block 910, wherein the UE 100 may begin a second PLMN scan corresponding to the second request. Here, the second PLMN scan may utilize the same first BST as utilized in the first PLMN scan. However, if at block 908 the UE determines that the time corresponding to the N_Min_manual_spacing timer 158 has not yet expired, then the process may proceed to block 912. Here, the UE 100 may determine whether the second request for PLMN scan corresponds to the same first SIM as the SIM corresponding to the first request for a PLMN scan, e.g., received at block 902. If the second request corresponds to the same SIM as the first request, then the process may proceed to block 916, wherein the UE 100 may ignore the second request to perform a PLMN scan, forgoing to perform the second PLMN scan.

On the other hand, if at block 912 the UE 100 determines that the second request received at block 906 corresponds to a different SIM than the first SIM corresponding to the first request received at block 902, then the process may proceed to block 914, wherein the UE 100 may initiate the second PLMN scan corresponding to the second request. Here, in some examples, the second PLMN scan may be configured to scan only for bands and/or RATs that are not included in the first BST corresponding to the first PLMN scan implemented at block 904.

In some examples, if a manual PLMN scan request is issued while the UE 100 is in an out-of-service (00S) state, or when the UE 100 is in a limited service state, the corresponding PLMN scans may be performed in the foreground.

### Automatic BST Updating

In a still further aspect of the disclosure, automatic updating of a BST 156 may be enabled. That is, there may be certain scenarios wherein one or more additional bands are deployed in a particular country. To account for such a case, the BST 156 utilized to optimize manual PLMN scans may be updated under certain conditions.

In general, the BST 156 provides a list of bands and/or RATs to be searched during a manual PLMN scan request. The BST 156 is filled out based on currently allowed bands and/or RATs in every country. For example, assume the UE 100 obtains service on a certain PLMN (e.g., called P1) corresponding to a band (B1) and/or a RAT (R1) in a certain MCC (e.g., called MCCX). Obtaining service on this PLMN may occur in an initial acquisition, e.g., following power-on of the UE 100, or in other examples, upon reselection from one network to another. In any case, if the BST 156 has an entry for MCCX, and B1/R1 is not listed in that entry, then in an aspect of the disclosure, that entry may be added to the entry for MCCX in the BST 156.

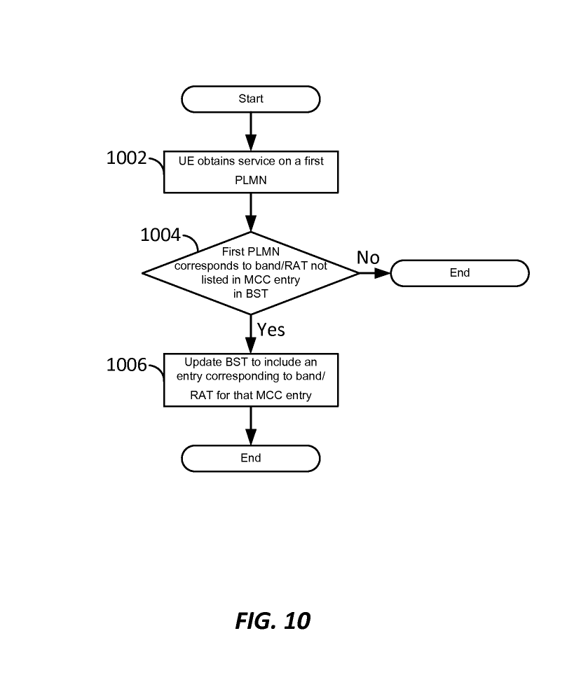

FIG. 10 is a flow chart illustrating an exemplary process 1000 of automatic updates to a BST, in accordance with some aspects of the disclosure. In some examples, the process 1000 may be implemented by the UE 100. In some examples, the process 1000 may be implemented by a suitably configured processor 104 or any other suitable means for performing the functions recited below.

For example, at block 1002, a UE 100 may obtain service on a first PLMN, e.g., by performing any suitable call initiation procedure corresponding to a mobile-terminated call or a mobile-initiated call. At block 1004, the UE 100 may determine whether the first PLMN, on which the service was obtained at block 1002, corresponds to a band and/or RAT that is not listed for a current MCC entry in a BST 156. If the first PLMN corresponds to a band/RAT that is listed in the MCC entry in the BST 156, then the process ends (i.e., no updates to the BST 156 are needed, as the BST already includes an entry for this PLMN corresponding to the band/RAT listed in the MCC entry in the BST 156). However, if the first PLMN corresponds to a band/RAT that is not listed in the MCC entry in the BST 156, then the process may proceed to block 1006, wherein the UE 100 may update the BST 156 to include an entry corresponding to the band and/or RAT for the current MCC.

### Aborting a Manual PLMN Scan on User Selection

In some examples, when incremental (e.g., partial) manual PLMN scan results are being shown to the user on the user interface 112, the list of PLMNs found at a given point in time may be sorted in a preferred order, and accordingly the user may be enabled to select a PLMN from the list at that moment. Here, if the user selects a PLMN from the available partial list, there is no need to continue with any remaining part of the ongoing manual PLMN scan. Therefore, in accordance with an aspect of the disclosure, any remaining part of the manual PLMN scan may be aborted in the case that the user selects a PLMN from the partial list.

In this case, in a further aspect of the disclosure, the corresponding band or RAT selected by the user is stored at the UE 100, to be kept as a priority band or RAT in future manual PLMN scans. That is, the BST 156 may be updated to indicate the selected band or mode is a high priority or preferred band or mode.

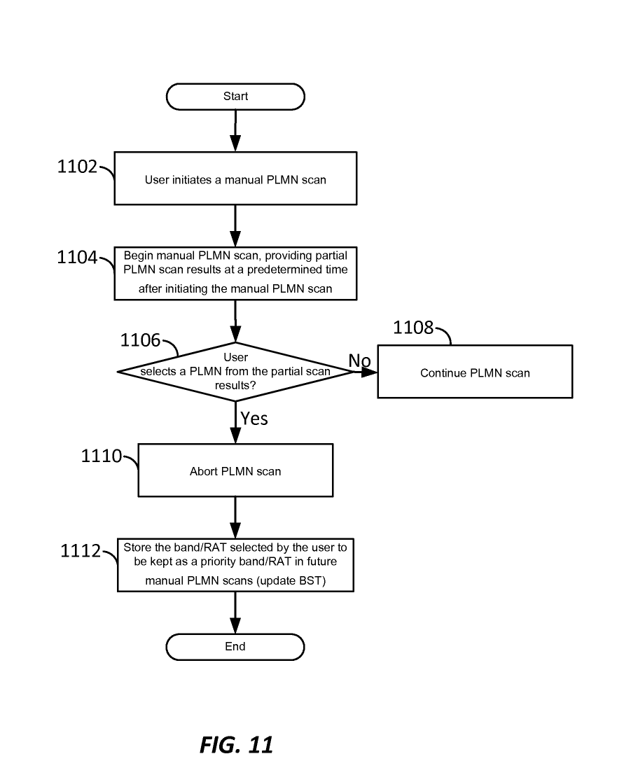

FIG. 11 is a flow chart illustrating an exemplary process 1100 of aborting a manual PLMN scan, in accordance with some aspects of the disclosure. In some examples, the process 1100 may be implemented by the UE 100. In some examples, the process 1100 may be implemented by a suitably configured processor 104 or any other suitable means for performing the functions recited below.

For example, the process 1100 starts at block 1102, wherein a user may initiate, e.g., utilizing the user interface 112, a manual PLMN scan. Thus, the UE 100 may receive a first request from the user to perform a manual PLMN scan, the scan corresponding to a first SIM (e.g., the SIM 107). At block 1104, the UE 100 may accordingly initiate a first PLMN scan (e.g., utilizing the PLMN scan circuit 140 and/or PLMN scan instructions 160) in accordance with a first BST 156. Here, the first PLMN scan may correspond to a partial PLMN scan, wherein the UE 100 provides partial PLMN results corresponding to an ongoing PLMN scan to the user after the initiating of the PLMN scan.

At block 1106, the UE 100 may determine whether the user has selected a PLMN from the partial scan results. That is, the user, e.g., utilizing the user interface 112, may select one of the PLMNs displayed to the user at that time during the partial PLMN scan results. If the user has not yet selected a PLMN, then the process may proceed to block 1108 and the PLMN scan may continue. If the user has selected a PLMN from the partial scan results, then the process may proceed to block 1110, and the UE 100 may abort the ongoing PLMN scan in response to the user selection of the PLMN from the partial PLMN scan results.

In a further aspect of the disclosure, at block 1112, the UE 100 may update the BST 156 to include a band and/or RAT corresponding to the selected PLMN, with this new entry being a priority band and/or RAT for future PLMN scans.

### Manual PLMN Scan on an Acquisition Database on all RATs Prior to Full Band Scan

In some examples, a wireless device such as the UE 100 may maintain an acquisition database (ACQ DB) 159 (see FIG. 1) that stores a list of entries for frequency channels and systems that have been acquired previously by the wireless device. Each entry in the acquisition database 159 may include a frequency channel, a scrambling code, system identification information, and/or other pertinent information to acquire the associated system.

In some examples, upon the initiation of a manual PLMN scan, the scan is first performed on the active RAT (full band scan), followed by a search on other RATs. However, this method can result in PLMNs on other RATs not being shown to the user until much later.

In an aspect of the present disclosure, the UE 100 may perform an ACQ DB search on all RATs prior to initiating a full band scan on any individual RAT (including the currently active RAT).

That is, upon receiving a manual PLMN scan request from the user, the UE 100 may first search the ACQ DB of all available RATs, and results (e.g., partial results) may be sent to the user. Here, the ACQ DB search can be relatively quick, and can provide the user with the most recently scanned PLMNs as a first partial result.

In a further aspect of the disclosure, a full band scan may be done on all RATs based on certain criteria, including but not limited to: the last RAT selected by the user in a manual selection; the acquisition order preference; or the current active RAT.

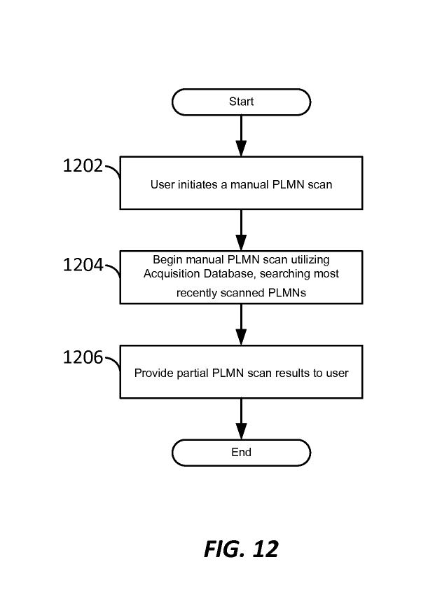

FIG. 12 is a flow chart illustrating an exemplary process 1200 of implementing a manual PLMN scan utilizing an Acquisition Database, in accordance with some aspects of the disclosure. In some examples, the process 1200 may be implemented by the UE 100. In some examples, the process 1200 may be implemented by a suitably configured processor 104 or any other suitable means for performing the functions recited below.

For example, the process 1200 starts at block 1202, wherein a user may initiate, e.g., utilizing the user interface 112, a manual PLMN scan. Thus, the UE 100 may receive a first request from the user to perform a manual PLMN scan, the scan corresponding to a first SIM (e.g., the SIM 107). At block 1204, the UE 100 may accordingly initiate a first PLMN scan (e.g., utilizing the PLMN scan circuit 140 and/or PLMN scan instructions 160) in accordance with an acquisition database 159. Here, the acquisition database 159 may include a list of recently scanned PLMNs, which were identified by the UE 100 in one or more recent PLMN scans. At block 1206, the UE 100 may provide partial PLMN results corresponding to an ongoing PLMN scan to the user after the initiating of the PLMN scan.

Full Band Scan on Remaining Bands if BST Search does not Yield any PLMNs

In the fast manual PLMN scan algorithm, as described above, a manual PLMN scan may be performed on the set of bands and/or RATs as found for the current or last acquired MCC. However, the BST 156 may be old, or in the case of border areas, the last-acquired MCC when the UE 100 is in an out-of-service state may provide a set of bands or RATs that are not applicable to the new area.

Therefore, in a further aspect of the disclosure, the manual PLMN scan may be divided into two stages. In a first stage, the manual PLMN scan may be performed as per the selected BST 156. In this stage, partial PLMN scan results may be provided, as described above. If the first stage is complete and does not provide any available PLMNs, then a second stage may be implemented. In the second stage, all remaining bands or RATs may be selected for the PLMN scan. Once again, periodic partial results may be provided to the user.

In the case that one or more PLMNs are found during the second stage search, corresponding bands and/or RATs may be added to the BST corresponding to that MCC.

Furthermore, if a PLMN is found corresponding to a different MCC than the current MCC, for further manual searches, until a new system is acquired, this MCC may utilize the BST for the search.

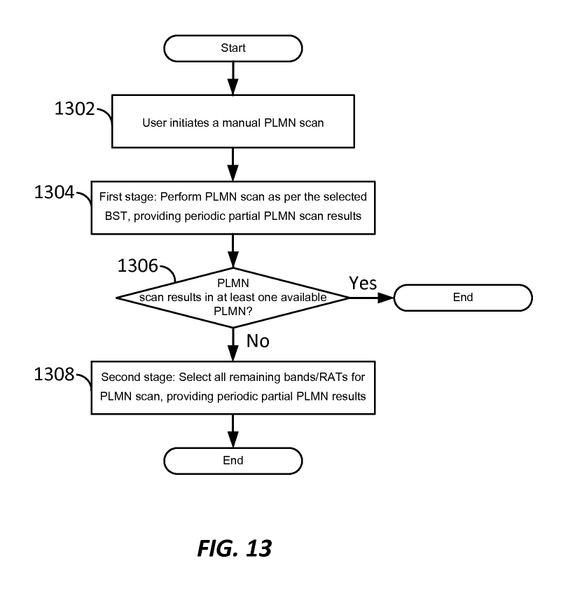

FIG. 13 is a flow chart illustrating an exemplary process 1300 of implementing a two-stage manual PLMN scan, in accordance with some aspects of the disclosure. In some examples, the process 1300 may be implemented by the UE 100. In some examples, the process 1300 may be implemented by a suitably configured processor 104 or any other suitable means for performing the functions recited below.

For example, the process 1300 starts at block 1302, wherein a user may initiate, e.g., utilizing the user interface 112, a manual PLMN scan. Thus, the UE 100 may receive a first request from the user to perform a manual PLMN scan, the scan corresponding to a first SIM (e.g., the SIM 107). At block 1304, the UE 100 may initiate a first stage of a manual PLMN scan as per a selected BST 156, wherein the UE 100 may provide periodic and/or intermittent partial PLMN scan results to the user, e.g., over the user interface 112.

At block 1306, the UE 100 may determine whether the ongoing PLMN scan has resulted in at least one available PLMN. If at least one available PLMN is identified during the PLMN scan, then the process may end, as the PLMN scan was successful. On the other hand, if the PLMN scan does not result in at least one available PLMN, then the process may proceed to block 1308, wherein the UE 100 may initiate a second stage of a manual PLMN scan, selecting all remaining bands and/or RATs for a continuing PLMN scan. Here, remaining bands and/or RATs may correspond to those bands and/or RATs for which the UE 100 is capable of utilizing, which do not correspond to the BST 156 utilized during the first stage of the PLMN scan at block 1304. Here, periodic and/or intermittent partial PLMN results may be provided to the user over the user interface 112 corresponding to the second stage scan.

### Further Optimizations to Manual PLMN Scan

In a further aspect of the disclosure, the manual PLMN scan may be performed in a semi-background fashion, wherein the UE 100 may skip one out of every n DRX wake-ups in order to perform the manual PLMN scan. That is, the UE 100 may be configured for a power saving feature wherein, according to a discontinuous reception (DRX) schedule, the UE 100 may power off certain circuitry, including but not limited to a receive circuit within a transceiver 110. This circuitry may wake up according to this DRX schedule, e.g., to listen for any incoming page message during the wake-up. Referring to FIG. 1, the UE 100 may include a DRX circuit 148 configured to communicate with and/or control the transceiver 110 to enable such DRX functionality.

In some DRX implementations, it is known by the UE 100 that the network may re-transmit page messages such that the page messages are available during two or more DRX wake-up periods. Therefore, if the UE 100 is configured to skip one or more DRX wake-up periods while performing the manual PLMN scan, incoming page messages generally would not be missed. Furthermore, this optimization can be adaptively turned on and off, based on channel conditions. For example, the semi-background scan may be turned on in good channel conditions, wherein the probability of page decoding failure is determined to be at an acceptably low level.

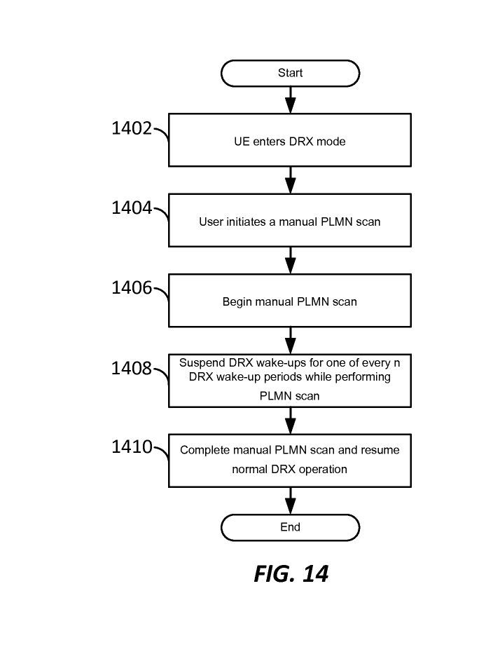

FIG. 14 is a flow chart illustrating an exemplary process 1400 of implementing a manual PLMN scan in a semi-background fashion, in accordance with some aspects of the disclosure. In some examples, the process 1400 may be implemented by the UE 100. In some examples, the process 1400 may be implemented by a suitably configured processor 104 or any other suitable means for performing the functions recited below.

For example, at block 1402, the UE 100, having an established link with a wireless communication network, may enter into a DRX mode (e.g., utilizing DRX circuitry 148 and/or DRX instructions 168). At block 1404, while the UE 100 is in the DRX mode, the user may initiate, e.g., utilizing the user interface 112, a manual PLMN scan. Thus, the UE 100 may receive a first request from the user to perform a manual PLMN scan, the scan corresponding to a first SIM (e.g., the SIM 107). At block 1406, the UE 100 may initiate a first PLMN scan (e.g., utilizing the PLMN scan circuit 140 and/or PLMN scan instructions 160) in accordance with a first BST 156. In some examples, the first PLMN scan may correspond to a partial PLMN scan, with partial PLMN results being provided to the user as described above; in other examples, the first PLMN scan may correspond to a full PLMN scan.

At block 1408, in an aspect of the present disclosure, the UE 100 may suspend at least a portion of DRX wake-ups corresponding to the DRX mode, while performing the first PLMN scan. For example, the DRX circuitry 148 and/or DRX instructions 168 may be configured to skip one or more DRX wake up periods or cycles while the PLMN scan is ongoing. At block 1410, the UE 100 may complete the manual PLMN scan, and resume normal DRX operations, e.g., by ending the suspension of at least a portion of DRX wake-up cycles or periods.

In yet another aspect of the disclosure, the UE 100 may utilize the system information blocks (SIBs) broadcast from the current serving cell, or SIBs that are read during the manual PLMN scan, in order to avoid certain frequencies in the PLMN scan. That is, the UE 100 may be configured to receive broadcasted system information on the SIBs, wherein one or more of the SIBs may include information relating to known neighbor base stations of the cell broadcasting the neighbor list. This neighbor list may, in some examples, be an inter-frequency neighbor list. Thus, in one example, in order to expedite the PLMN scan, the UE 100 may forgo to scan frequencies listed in an inter-frequency neighbor list, since these frequencies would contain the same PLMN.

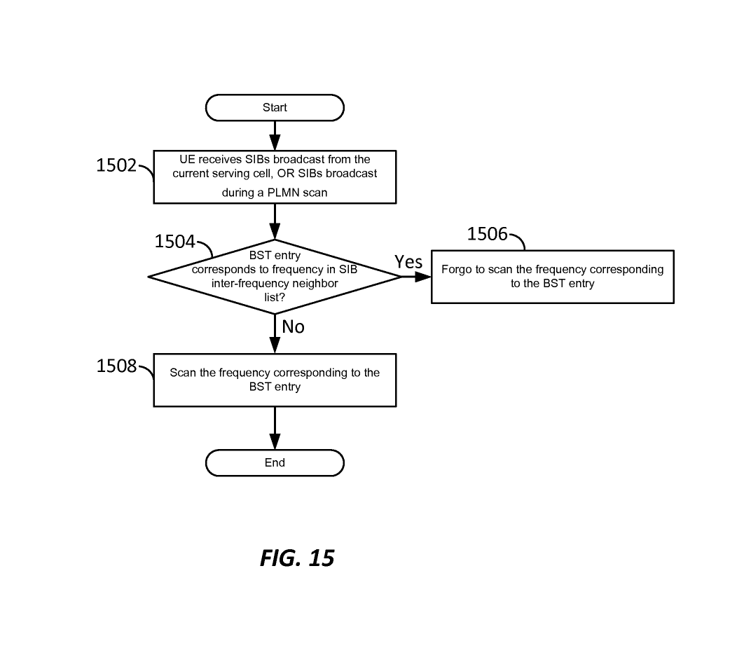

FIG. 15 is a flow chart illustrating an exemplary process 1500 of utilizing information in SIBs to alter a manual PLMN scan, in accordance with some aspects of the disclosure. In some examples, the process 1500 may be implemented by the UE 100. In some examples, the process 1500 may be implemented by a suitably configured processor 104 or any other suitable means for performing the functions recited below.

For example, at block 1502 the UE 100 may receive system information, which may be carried on one or more system information blocks (SIBs) broadcasted from the UE's current serving cell, or from one or more neighbor cell(s), during an ongoing PLMN scan (e.g., a manual PLMN scan utilizing any one or more of the above-described methods or procedures). Here, at block 1504, the UE 100 may determine whether any one or more entries in a selected BST 156 correspond to a frequency in an inter-frequency neighbor list carried on the received SIB. If a frequency corresponding to an entry in the BST 156 corresponds to one of the frequencies in the inter-frequency neighbor list, then the process may proceed to block 1506, wherein the UE 100 may forgo to scan the frequency corresponding to the BST entry. On the other hand, if there is no BST entry that corresponds to any frequencies in the inter-frequency neighbor list, then the process may proceed to block 1508, wherein the UE 100 may scan the frequency corresponding to the BST entry, as a PLMN that might be found doing such scan would correspond to a different PLMN other than the one currently serving the UE 100.

### Simplified Use of BST in China

In some cases, the utilization of the BST 156 as described above, wherein potentially large sets of bands and MCCs may be enabled for an open market handset, may introduce more complexity than needed. That is, in the case where the UE 100 is generally expected to be geographically limited, such as to remain within a certain country or continent, certain simplifications to the above-described usage of the BST 156 may be implemented.

As one example, described herein below for clarity, a use case targeted to China is described. However, this example is not intended to be limiting on the disclosure, and those skilled in the art will recognize that similar implementations may be deployed in any suitable country or region, by replacing China in the following description with any other suitable country, region, or MCC.

In one aspect of the disclosure, a UE 100 may support utilizing the BST for optimizing manual PLMN scans. Here, when the user, e.g., using the user interface 112, issues a manual PLMN scan request, the UE 100 may check whether there exists a BST 156 in the memory 105 of the UE 100. If there is a BST 156, the UE 100 may utilize the current MCC of operation to determine which BST record to utilize.

Here, if the current MCC is the MCC for China, and the SIM 107 in the UE 100 is a CMCC SIM, then the UE 100 may scan for TD-SCDMA RATs before scanning for W-CDMA RATs (i.e., with the knowledge that the TD-SCDMA air interface for 3GPP UMTS technology is widely utilized within China, rather than the W-CDMA air interface). For example, referring to Table 3 below, RAT4 is illustrated as a record in the BST corresponding to a TD-SCDMA RAT. In an aspect of the disclosure, if the current MCC corresponds to China, then in some cases the UE 100 may scan all the bands and RATs, but scanning the TS-SCDMA entries such as RAT 4 prior to scanning other entries, such as those corresponding to W-CDMA.

TABLE 3

MCC_INCL =0 (default band list)
RAT1 (LTE) : Band X, Band Y
RAT2 (UMTS) : 2.1GHz, 1.8GHz, 850Mhz, 1.7GHz
RAT3 (GSM) : GSM900, GSM800, GSM1900, GSM1800
RAT4 (TDSC2K) . Band1880, 2010

MCC_INCL =1, 460 (China MCC)

PLMN-ID = * (UMTS) : Band 2.1G
PLMN-ID = * (GSM) : GSM900, GSM1800
PLMN-ID = * (TDSC2K) : Band 1880, 2010
MCC_INCL =1, 404, 405 (India MCC)

PLMN-ID = * (UMTS) : UMTS 2.1G
PLMN-ID = * (GSM) : GSM 900, GSM1800

However, if the current MCC is not the MCC for China, but a record exists in the BST for the current MCC, then the UE 100 may scan the bands and/or RATs associated with the default (i.e., PLMN-ID=*) record for the MCC. Moreover, if no record exists for the current MCC, or if the current MCC cannot be determined (e.g., if the UE 100 is out of service when the scan was issued), then the UE 100 may scan the bands and/or RATs associated with the default MCC record, as in the conventional case.

In this example, as illustrated above in Table 3, the BST 156 may have two MCC-specific entries, which list the smaller set of bands supported in China and India. Therefore, a UE 100 that is camped in India or China may restrict its scans to a much more limited set of bands and/or RATs, as opposed to the open market handset. However, when the UE 100 camps in other countries, or when the MCC is unknown, the list of bands and RATs in a default MCC record may be scanned, leading to longer scan times.

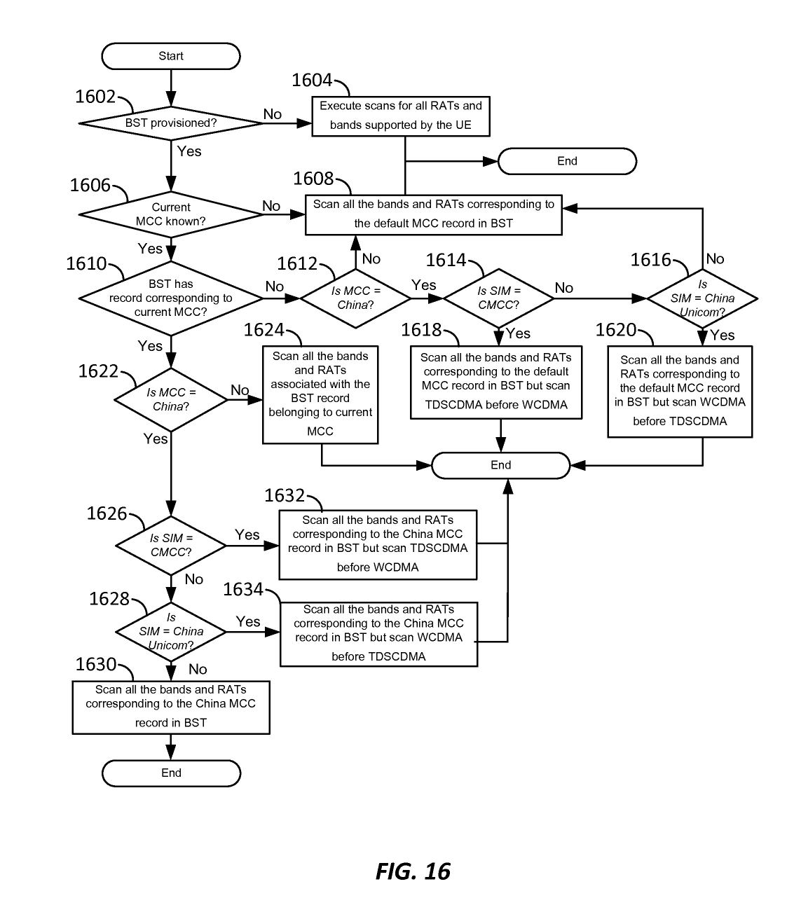

FIG. 16 is a flow chart illustrating an exemplary process 1600 of utilizing a BST 156 as described herein below to expedite a PLMN scan, in accordance with one or more aspects of the disclosure corresponding to the China use case. In some examples, the process 1600 may be implemented by the UE 100. In some examples, the process 1600 may be implemented by a suitably configured processor 104 or any other suitable means for performing the functions recited below.

Here, the process may start upon receipt of a manual instruction from a user to initiate a manual PLMN scan. At block 1602, the UE 100 may determine whether one or more BST(s) 156 have been provisioned in the UE memory 105. If no BST 156 is provisioned, then at block 1604 the UE 100 may execute a PLMN scan for all RATs and/or bands that the UE 100 supports. On the other hand, if one or more BSTs 156 have been provisioned, then at block 1606, the UE 100 may determine whether the current MCC corresponding to the country where the UE 100 is located is known. If the current MCC is not known, then the process may proceed to block 1608, wherein the UE 100 may implement a PLMN scan, scanning for all of the bands and RATs that correspond to a default MCC record in the selected BST 156. On the other hand, if the current MCC is known, then the process may proceed to block 1610, wherein the UE 100 may determine whether the selected BST 156 has a record corresponding to the current detected MCC. If the BST 156 does not have a record corresponding to the current detected MCC, then the process may proceed to block 1612, wherein the UE 100 may determine whether the current detected MCC is that of China. If the current detected MCC is not that of China, then the process may return to block 1608, wherein the UE 100 may scan all of the bands and/or RATs corresponding to the default MCC record in the selected BST 156. On the other hand, if the current detected MCC is that of China, then the process may proceed to block 1614, wherein the UE 100 may determine whether the SIM 107 is configured for a China Mobile Communications Corporation (CMCC) subscription, and similarly, at block 1616, the UE 100 may determine whether the SIM 107 is configured for a China Unicom subscription. If no to either CMCC or China Unicom, then the process may proceed to block 1608, wherein the UE 100 may scan all of the bands and/or RATs corresponding to the default MCC record in the selected BST 156. However, if the SIM 107 is configured for CMCC or China Unicom, then the process may scan all the bands and/or RATs corresponding to the default MCC record in the selected BST, scanning for TD-SCDMA before W-CDMA in the case that the SIM is configured for CMCC (block 1618), and scanning for W-CDMA before TD-SCDMA in the case that the SIM is configured for China Unicom (block 1620).

Returning again to block 1610, if the selected BST 156 does have a record corresponding to the current detected MCC, then the process may proceed to block 1622, wherein the UE 100 may determine whether the currently detected MCC corresponds to that of China. If the current detected MCC does not correspond to that of China, then the process may proceed to block 1624, wherein the UE 100 may scan all of the bands and/or RATs that are associated with the BST record that belong to the current detected MCC.

On the other hand, if at block 1622 the UE 100 determines that the current detected MCC corresponds to that of China, then the process may proceed to block 1626, wherein the UE 100 may determine whether the SIM 107 is configured for a China Mobile Communications Corporation (CMCC) subscription, and similarly, at block 1628, the UE 100 may determine whether the SIM 107 is configured for a China Unicom subscription. If no to either CMCC or China Unicom, then the process may proceed to block 1630, wherein the UE 100 may scan all of the bands and/or RATs corresponding to the China MCC record in the selected BST 156. However, if the SIM 107 is configured for CMCC or China Unicom, then the process may scan all the bands and/or RATs corresponding to the China MCC record in the selected BST, scanning for TD-SCDMA before W-CDMA in the case that the SIM is configured for CMCC (block 1632), and scanning for W-CDMA before TD-SCDMA in the case that the SIM is configured for China Unicom (block 1634).

Several aspects of a telecommunications system have been presented with reference to a W-CDMA system. As those skilled in the art will readily appreciate, various aspects described throughout this disclosure may be extended to other telecommunication systems, network architectures and communication standards.

By way of example, various aspects may be extended to other UMTS systems such as TD-SCDMA and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

1. A method of wireless communication operable at a user equipment (UE), comprising:
receiving a first request corresponding to a first subscriber identity module (SIM), to perform a public land mobile network (PLMN) scan;
determining a service provider in accordance with information on the SIM; and
initiating a first PLMN scan in accordance with a first band support table (BST) comprising a service provider field, wherein the service provider field matches the determined service provider in accordance with information on the SIM.

2. The method of claim 1, wherein the BST further comprises a PLMN identifier (PLMN ID) field configured to indicate one or more bands and/or radio access technologies corresponding to a home PLMN, such that the first PLMN scan initially scans for the one or more bands and/or radio access technologies corresponding to the home PLMN.

3. The method of claim 1, wherein the BST further comprises a channel information element corresponding to a first mobile country code (MCC) and/or PLMN, the channel information element configured to indicate a known channel, such that the PLMN scan, when scanning for the first MCC and/or PLMN initially scans for the known channel.

4. The method of claim 1, further comprising determining a location of the UE,
wherein the BST further comprises a band information element corresponding to a predetermined location, the band information element configured to indicate a known band, such that when the determined location corresponds to the predetermined location, the PLMN scan initially scans for the known band.

5. The method of claim 1, further comprising:
determining a mobile country code (MCC) corresponding to a current location of the UE,
wherein the PLMN scan is configured to scan for bands and/or RATs corresponding to the determined MCC in accordance with the first BST.

6. The method of claim 1, further comprising:
receiving a second request to perform a second PLMN scan; and
if the second request is within less than a predetermined interval from the first request, ignoring the second request and forgoing to perform the second PLMN scan.

7. The method of claim 1, further comprising:
receiving a second request to perform a second PLMN scan;
if the second request corresponds to the first SIM, and if the second request is within less than a predetermined interval from the first request, ignoring the second request and forgoing to perform the second PLMN scan; and
if the second request corresponds to a SIM other than the first SIM, and if the second request is within less than the predetermined interval from the first request, initiating a second PLMN scan corresponding to the second request.

8. The method of claim 7, wherein the second PLMN scan is configured to scan only for bands and/or radio access technologies (RATs) that are not included in the first BST.

9. The method of claim 1, further comprising:
obtaining service on a first PLMN; and
if the first PLMN corresponds to a band and/or RAT not listed for a current mobile country code (MCC), updating the BST to include an entry corresponding to the band and/or RAT for the current MCC.

10. The method of claim 1, further comprising:
providing partial PLMN scan results corresponding to an ongoing PLMN scan after the initiating the PLMN scan; and
aborting the PLMN scan in response to a user selection of a first PLMN from the partial PLMN scan results.

11. The method of claim 10, further comprising:
updating the BST to include a band and/or RAT corresponding to the selected first PLMN as a priority band and/or RAT for future PLMN scans.

12. The method of claim 1, wherein the first PLMN scan is further in accordance with an acquisition database comprising a list of recently scanned PLMNs.

13. The method of claim 1, wherein if the first PLMN scan corresponding to the first BST does not result in at least one available PLMN, the method further comprises selecting all remaining bands and/or RATs for a continuing PLMN scan.

14. The method of claim 1, further comprising:
suspending at least a portion of wake-ups corresponding to a discontinuous reception (DRX) mode while performing the first PLMN scan.

15. The method of claim 1, further comprising:
receiving a system information block (SIB) broadcasted from a current serving cell, or from a neighbor cell during the first PLMN scan, the SIB comprising an inter-frequency neighbor list; and
if a first frequency corresponding to an entry in the first BST corresponds to a frequency in the inter-frequency neighbor list, forgoing to scan the first frequency.

16. The method of claim 1, further comprising:
determining a mobile country code (MCC) corresponding to a current location of the UE; and
if the MCC corresponds to a first country, the first PLMN scan initially scans for bands and/or RATs corresponding to a first air interface utilized in the first country.

17. The method of claim 16, wherein the first country is China, and wherein the first air interface is a time division synchronous code division multiple access (TD-SCDMA) air interface.

18. A user equipment (UE) configured for wireless communication, comprising:
at least one processor;
a memory communicatively coupled to the at least one processor; and
a transceiver communicatively coupled to the at least one processor,
wherein the at least one processor is configured to:
receive a first request corresponding to a first subscriber identity module (SIM), to perform a public land mobile network (PLMN) scan;
determine a service provider in accordance with information on the SIM; and
initiate a first PLMN scan in accordance with a first band support table (BST) comprising a service provider field, wherein the service provider field matches the determined service provider in accordance with information on the SIM.

19. The UE of claim 18, wherein the BST further comprises a PLMN identifier (PLMN ID) field configured to indicate one or more bands and/or radio access technologies corresponding to a home PLMN, such that the first PLMN scan initially scans for the one or more bands and/or radio access technologies corresponding to the home PLMN.

20. The UE of claim 18, wherein the BST further comprises a channel information element corresponding to a first mobile country code (MCC) and/or PLMN, the channel information element configured to indicate a known channel, such that the PLMN scan, when scanning for the first MCC and/or PLMN initially scans for the known channel.

21. The UE of claim 18, wherein the at least one processor is further configured to:
determine a mobile country code (MCC) corresponding to a current location of the UE,
wherein the PLMN scan is configured to scan for bands and/or RATs corresponding to the determined MCC in accordance with the first BST.

22. A non-transitory computer-readable storage medium comprising instructions for causing a computer to:
receive a first request corresponding to a first subscriber identity module (SIM), to perform a public land mobile network (PLMN) scan;
determine a service provider in accordance with information on the SIM; and
initiate a first PLMN scan in accordance with a first band support table (BST) comprising a service provider field, wherein the service provider field matches the determined service provider in accordance with information on the SIM.

23. The non-transitory computer-readable storage medium of claim 22, further comprising instructions for causing a computer to receive a second request to perform a second PLMN scan; and
instructions for causing a computer, if the second request is within less than a predetermined interval from the first request, to ignore the second request and forgoing to perform the second PLMN scan.

24. The non-transitory computer-readable storage medium of claim 22, further comprising instructions for causing a computer to:
receive a second request to perform a second PLMN scan;
instructions for causing a computer, if the second request corresponds to the first SIM, and if the second request is within less than a predetermined interval from the first request, to ignore the second request and forgoing to perform the second PLMN scan; and
instructions for causing a computer, if the second request corresponds to a SIM other than the first SIM, and if the second request is within less than the predetermined interval from the first request, to initiate a second PLMN scan corresponding to the second request.

25. The non-transitory computer-readable storage medium of claim 22, further comprising:
instructions for causing a computer to obtain service on a first PLMN; and
instructions for causing a computer, if the first PLMN corresponds to a band and/or RAT not listed for a current mobile country code (MCC), to update the BST to include an entry corresponding to the band and/or RAT for the current MCC.

26. The non-transitory computer-readable storage medium of claim 22, further comprising:
instructions for causing a computer to provide partial PLMN scan results corresponding to an ongoing PLMN scan after the initiating the PLMN scan; and
instructions for causing a computer to abort the PLMN scan in response to a user selection of a first PLMN from the partial PLMN scan results.

27. A user equipment (UE) configured for wireless communication, comprising:
means for receiving a first request corresponding to a first subscriber identity module (SIM), to perform a public land mobile network (PLMN) scan;
means for determining a service provider in accordance with information on the SIM; and
means for initiating a first PLMN scan in accordance with a first band support table (BST) comprising a service provider field, wherein the service provider field matches the determined service provider in accordance with information on the SIM.

28. The UE of claim 27, wherein the first PLMN scan is further in accordance with an acquisition database comprising a list of recently scanned PLMNs.

29. The UE of claim 27, further comprising means, if the first PLMN scan corresponding to the first BST does not result in at least one available PLMN, for selecting all remaining bands and/or RATs for a continuing PLMN scan.

30. The UE of claim 27, further comprising:
means for determining a mobile country code (MCC) corresponding to a current location of the UE; and
if the MCC corresponds to a first country, the means for initiating the first PLMN scan is configured initially to scan for bands and/or RATs corresponding to a first air interface utilized in the first country.
